(19) United States
(12) Patent Application Publication
(10) Pub. No.: US 2023/0185987 A1
(43) Pub. Date: Jun. 15, 2023

(54) DERIVING FOUNDRY FABRICATION MODELS FROM PERFORMANCE MEASUREMENTS OF FABRICATED DEVICES

(71) Applicant: X Development LLC, Mountain View, CA (US)

(72) Inventors: Ardavan Oskooi, Mill Valley, CA (US); Martin Schubert, Mountain View, CA (US); Cyril Pierre Bortolato, Mountain View, CA (US)

(21) Appl. No.: 17/551,514

(22) Filed: Dec. 15, 2021

(51) Int. Cl. G06F 30/20

(52) U.S. Cl. CPC G06F 30/20

(57) ABSTRACT

In some embodiments, a non-transitory computer-readable medium is provided. The computer-readable medium has logic stored thereon that, in response to execution by one or more processors of a computing system, cause the computing system to perform actions for deriving a fabrication model for a fabrication system using an inverse design process. The actions include determining a test design for a test physical device, measuring performance of an instance of the test physical device fabricated by the fabrication system using the test design to determine an as-fabricated performance metric, optimizing the test design using a first loss function based on differences in a simulated performance metric of the test design and the as-fabricated performance metric to determine an as-fabricated design, and optimizing a fabrication model using a second loss function based on differences between the test design and the as-fabricated design.

### TECHNICAL FIELD

This disclosure relates generally to the design of physical devices for fabrication, and in particular but not exclusively, relates to photonic devices including but not limited to optical multiplexers and demultiplexers.

### BACKGROUND

Fiber-optic communication is typically employed to transmit information from one place to another via light that has been modulated to carry the information. For example, many telecommunication companies use optical fiber to transmit telephone signals, internet communication, and cable television signals. But the cost of deploying optical fibers for fiber-optic communication may be prohibitive. As such, techniques have been developed to more efficiently use the bandwidth available within a single optical fiber. Wavelength-division multiplexing is one such technique that bundles multiple optical carrier signals onto a single optical fiber using different wavelengths. Fabrication techniques used to create physical devices such as photonic devices for use in these contexts can create complex physical structures, but a fabricated physical device may differ from the design of the physical device due to specifics of the fabrication process as implemented by a particular fabrication system.

### BRIEF SUMMARY

In some embodiments, a non-transitory computer-readable medium is provided. The computer-readable medium has logic stored thereon that, in response to execution by one or more processors of a computing system, cause the computing system to perform actions for deriving a fabrication model for a fabrication system using an inverse design process. The actions include determining a test design for a test physical device, measuring performance of an instance of the test physical device fabricated by the fabrication system using the test design to determine an as-fabricated performance metric, optimizing the test design using a first loss function based on differences in a simulated performance metric of the test design and the as-fabricated performance metric to determine an as-fabricated design, optimizing a fabrication model using a second loss function based on differences between the test design and the as-fabricated design, and storing the optimized fabrication model for use in optimization of a new design for a new physical device.

In some embodiments, a non-transitory computer-readable medium is provided. The computer-readable medium has logic stored thereon that, in response to execution by one or more processors of a computing system, cause the computing system to perform actions for deriving a fabrication model for a fabrication system using an inverse design process. The actions include determining a test design for a test physical device, measuring performance of an instance of the test physical device fabricated by the fabrication system using the test design to determine an as-fabricated performance metric, determining structural parameters for a simulation based on the test design and the fabrication model, simulating performance of the test design using the structural parameters to determine a simulated performance metric, optimizing the fabrication model using a loss function based on differences between the simulated performance metric and the as-fabricated performance metric, and storing the optimized fabrication model for use in optimization of a new design for a new physical device.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a functional block diagram illustrating a non-limiting example embodiment of a system for optical communication between two optical communication devices via an optical signal, according to various aspects of the present disclosure.

FIG. 2A and FIG. 2B respectively illustrate a non-limiting example embodiment of a demultiplexer and multiplexer, according to various aspects of the present disclosure.

FIG. 2C illustrates a non-limiting example embodiment of a distinct wavelength channel of a multi-channel optical signal, according to various aspects of the present disclosure.

FIG. 3A-FIG. 3D illustrate different views of a non-limiting example embodiment of a photonic demultiplexer, according to various aspects of the present disclosure.

FIG. 4A and FIG. 4B illustrate a more detailed cross-sectional view of a dispersive region of a non-limiting example embodiment of a photonic demultiplexer, according to various aspects of the present disclosure.

FIG. 5 is a functional block diagram illustrating a non-limiting example embodiment of a system for generating a design of a photonic integrated circuit, according to various aspects of the present disclosure.

FIG. 6A illustrates a non-limiting example embodiment of a virtual prototype describing a photonic integrated circuit, according to various aspects of the present disclosure.

FIG. 6B illustrates a non-limiting example embodiment of an operational simulation of a photonic integrated circuit, according to various aspects of the present disclosure.

FIG. 6C illustrates a non-limiting example embodiment of an adjoint simulation within the virtual prototype by backpropagating a loss value, according to various aspects of the present disclosure.

FIG. 7A is a flow chart illustrating example time steps for an operational simulation and an adjoint simulation, in accordance with various aspects of the present disclosure.

FIG. 7B is a chart illustrating the relationship between the update operation for the operational simulation and the adjoint simulation (e.g., backpropagation), in accordance with an embodiment of the present disclosure.

FIG. 8A-FIG. 8B are a flowchart that illustrates a non-limiting example embodiment of a method 800 for optimizing a fabrication model usable to simulate fabrication of a physical device such as a photonic integrated circuit, in accordance with various aspects of the present disclosure.

FIG. 9A-FIG. 9B are a flowchart that illustrates a non-limiting example embodiment of a method 900 for optimizing a fabrication model usable to simulate fabrication of a physical device such as a photonic integrated circuit, in accordance with various aspects of the present disclosure.

### DETAILED DESCRIPTION

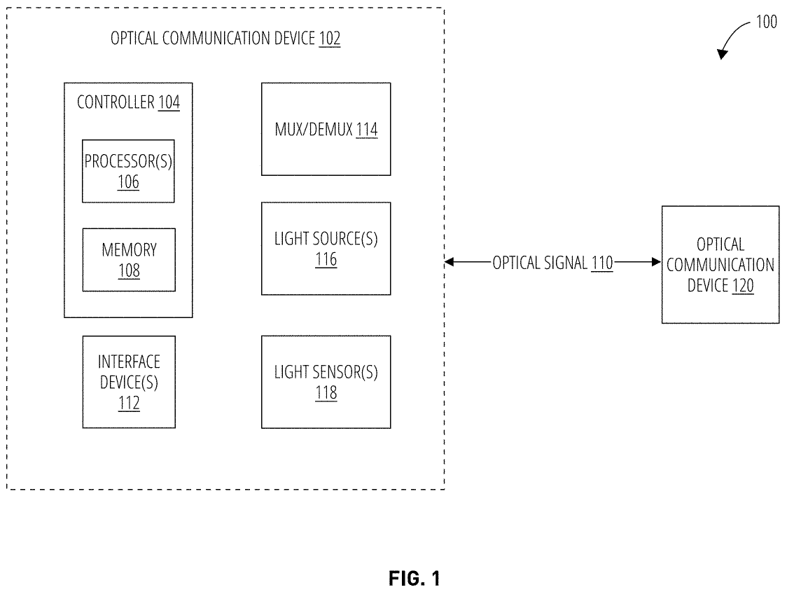

FIG. 1 is a functional block diagram illustrating a system 100 for optical communication (e.g., via wavelength division multiplexing or other techniques) between optical communication device 102 and optical communication device 120 via optical signal 110, in accordance with various aspects of the present disclosure. More generally, optical communication device 102 is configured to transmit information by modulating light from one or more light sources into a multi-channel optical signal 110 (e.g., a singular optical signal that includes a plurality of distinct wavelength channels) that is subsequently transmitted from optical communication device 102 to optical communication device 120 via an optical fiber, a light guide, a wave guide, or other photonic device. Optical communication device 120 receives the multi-channel optical signal 110 and demultiplexes each of the plurality of distinct wavelength channels from the multi-channel optical signal 110 to extract the transmitted information. It is appreciated that in some embodiments optical communication device 102 and optical communication device 120 may be distinct and separate devices (e.g., an optical transceiver or transmitter communicatively coupled via one or more optical fibers to a separate optical transceiver or receiver). However, in other embodiments, optical communication device 102 and optical communication device 120 may be part of a singular component or device (e.g., a smartphone, a tablet, a computer, optical device, or the like). For example, optical communication device 102 and optical communication device 120 may both be constituent components on a monolithic integrated circuit that are coupled to one another via a waveguide that is embedded within the monolithic integrated circuit and is adapted to carry optical signal 110 between optical communication device 102 and optical communication device 120 or otherwise transmit the optical signal between one place and another.

In the illustrated embodiment, optical communication device 102 includes a controller 104, one or more interface device(s) 112 (e.g., fiber optic couplers, light guides, waveguides, and the like), a multiplexer (mux), demultiplexer (demux), or combination thereof (MUX/DEMUX 114), one or more light source(s) 116 (e.g., light emitting diodes, lasers, and the like), and one or more light sensor(s) 118 (e.g., photodiodes, phototransistors, photoresistors, and the like) coupled to one another. The controller includes one or more processor(s) 106 (e.g., one or more central processing units, application specific circuits, field programmable gate arrays, or otherwise) and memory 108 (e.g., volatile memory such as DRAM and SAM, non-volatile memory such as ROM, flash memory, and the like). It is appreciated that optical communication device 120 may include the same or similar elements as optical communication device 102, which have been omitted for clarity.

Controller 104 orchestrates operation of optical communication device 102 for transmitting and/or receiving optical signal 110 (e.g., a multi-channel optical signal having a plurality of distinct wavelength channels or otherwise). Controller 104 includes software (e.g., instructions included in memory 108 coupled to processor 106) and/or hardware logic (e.g., application specific integrated circuits, field-programmable gate arrays, and the like) that when executed by controller 104 causes controller 104 and/or optical communication device 102 to perform operations.

In one embodiment, controller 104 may choreograph operations of optical communication device 102 to cause light source(s) 116 to generate a plurality of distinct wavelength channels that are multiplexed via MUX/DEMUX 114 into a multi-channel optical signal 110 that is subsequently transmitted to optical communication device 120 via interface device 112. In other words, light source(s) 116 may output light having different wavelengths (e.g., 1271 nm, 1291 nm, 1311 nm, 1331 nm, 1506 nm, 1514 nm, 1551 nm, 1571, or otherwise) that may be modulated or pulsed via controller 104 to generate a plurality of distinct wavelength channels representative of information. The plurality of distinct wavelength channels are subsequently combined or otherwise multiplexed via MUX/DEMUX 114 into a multi-channel optical signal 110 that is transmitted to optical communication device 120 via interface device 112. In the same or another embodiment, controller 104 may choreograph operations of optical communication device 102 to cause a plurality of distinct wavelength channels to be demultiplexed via MUX/DEMUX 114 from a multi-channel optical signal 110 that is received via interface device 112 from optical communication device 120.

It is appreciated that in some embodiments certain elements of optical communication device 102 and/or optical communication device 120 may have been omitted to avoid obscuring certain aspects of the disclosure. For example, optical communication device 102 and optical communication device 120 may include amplification circuitry, lenses, or components to facilitate transmitting and receiving optical signal 110. It is further appreciated that in some embodiments optical communication device 102 and/or optical communication device 120 may not necessarily include all elements illustrated in FIG. 1. For example, in one embodiment optical communication device 102 and/or optical communication device 120 are passive devices that operate as an intermediary device that may passively multiplex a plurality of distinct wavelength channels into a multi-channel optical signal 110 and/or demultiplex a plurality of distinct wavelength channels from a multi-channel optical signal 110.

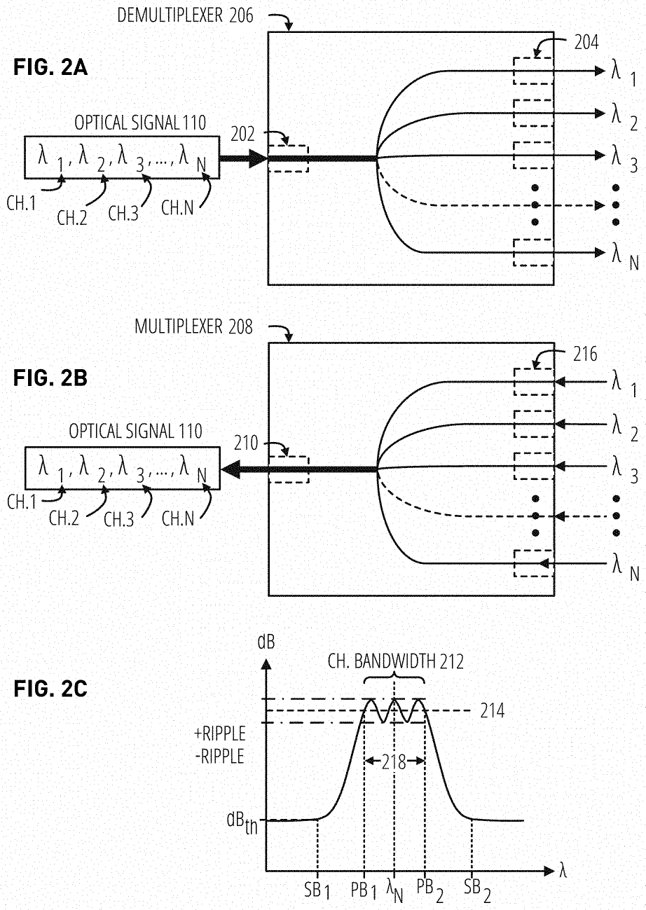

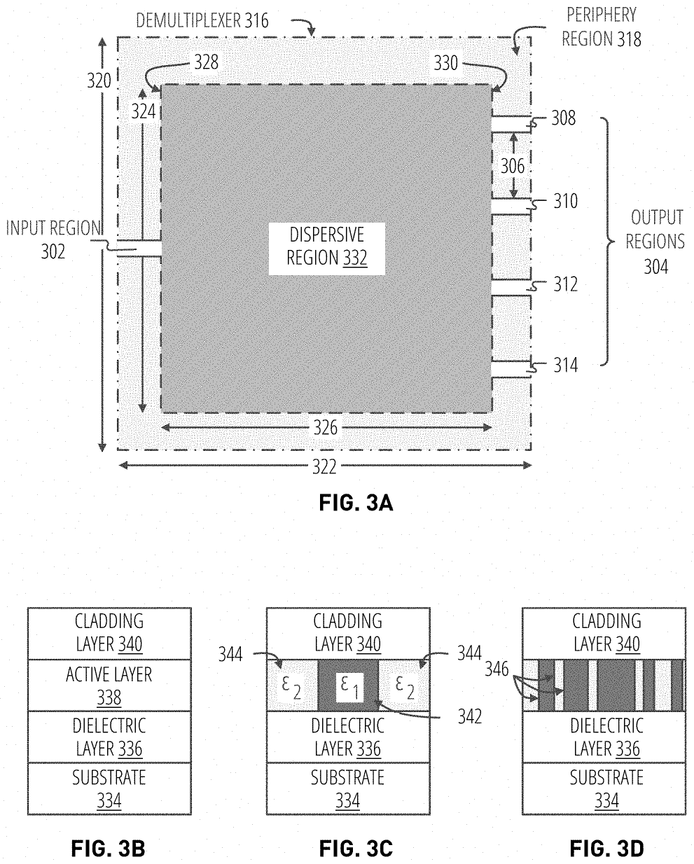

FIG. 2A and FIG. 2A respectively illustrate an example demultiplexer 206 and multiplexer 208, in accordance with various aspects of the present disclosure. Demultiplexer 206 and multiplexer 208 are possible embodiments of MUX/DEMUX 114 illustrated in FIG. 1, and which may be part of an integrated photonic circuit, silicon photonic device, or otherwise

As illustrated in FIG. 2A, demultiplexer 206 includes an input region 202 and a plurality of output regions 204. Demultiplexer 206 is configured to receive a multi-channel optical signal 110 that includes a plurality of distinct wavelength channels (e.g., Ch. 1, Ch. 2, Ch. 3, . . . Ch. N, each having a center wavelength respectively corresponding to λ₁, λ₂, λ₃, . . . λ_{N}) via input region 202 (e.g., a waveguide that may correspond to interface device 112 illustrated in FIG. 1) to optically separate each of the plurality of distinct wavelength channels from the multi-channel optical signal 110 and respectively guide each of the plurality of distinct wavelength channels to a corresponding one of a plurality of output regions 204 (e.g., a plurality of waveguides that may correspond to interface device(s) 112 illustrated in FIG. 1). More specifically, in the illustrated embodiment, each of the output regions 204 receives a portion of the multi-channel optical signal that corresponds to, or is otherwise representative of, one of the plurality of distinct wavelength channels that may be output as plurality of optical signals (e.g., λ₁, λ₂, λ₃, . . . λ_{N}). Each output region 204 may be coupled to a respective light sensor (e.g., corresponding to light sensor(s) 118 illustrated in FIG. 1), which may be utilized to convert the optical signals demultiplexed from the multi-channel optical signal 110 into electrical signals for further processing.

In the illustrated embodiment of FIG. 2B, multiplexer 208 includes a plurality of input regions 216 and an output region 210. Multiplexer 208 is configured to receive a plurality of distinct optical signals (e.g., λ₁, λ₂, λ₃, . . . λ_{N}), each at a respective one of the plurality of input regions 216 (e.g., a plurality of waveguides that may correspond to interface device(s) 112 illustrated in FIG. 1). Multiplexer 208 is structured or otherwise configured to optically combine (i.e., multiplex) each of the plurality of distinct wavelength channels into a multi-channel optical signal 110 that is guided to output region 210 (e.g., a waveguide that may correspond to interface device 112 illustrated in FIG. 1). It is appreciated that in some embodiments, demultiplexer 206 illustrated in FIG. 2A and multiplexer 208 illustrated in FIG. 2B may be bidirectional such that each device may function as both a demultiplexer and multiplexer.

FIG. 2C illustrates an example distinct wavelength channel of a multi-channel optical signal (e.g., Ch. N is multi-channel optical signal 110 illustrated in FIG. 1, FIG. 2A, and FIG. 2B), in accordance with various aspects of the present disclosure. The example channel may be representative of an individual channel included in a plurality of distinct wavelength channels of the multi-channel optical signal that may be demultiplexed and/or multiplexed by demultiplexer 206 of FIG. 2A and/or multiplexer 208 of FIG. 2B. Each of the distinct wavelength channels may have different center wavelengths (λ_{N}) including at least one of 1271 nm, 1291 nm, 1311 nm, 1331 nm, 1506 nm, 1514 nm, 1551 nm, or 1571 nm, or otherwise. In the illustrated embodiment of FIG. 2C, the distinct wavelength channel has a channel bandwidth 212 of approximately 13 nm wide. However, in other embodiments the channel bandwidth may be different than 13 nm wide. Rather, the channel bandwidth may be considered a configurable parameter that is dependent upon the structure of MUX/DEMUX 114 of FIG. 1, demultiplexer 206 of FIG. 2A, and/or multiplexer 208 of FIG. 2B. For example, in some embodiments each of the plurality of distinct wavelength channels may share a common bandwidth that may correspond to 13 nm or otherwise. Referring back to FIG. 2C, the channel bandwidth 212 may be defined as the width of a passband region 218 (i.e., the region defined as being between PB₁ and PB₂). The passband region 218 may represent an approximate power transmission of a demultiplexer or multiplexer. It is appreciated that in some embodiments the passband region 218 may include ripple as illustrated in FIG. 2C, which corresponds to fluctuations within the passband region 218. In one or more embodiments, the ripple within the passband region around a central value 214 may be +/−2 dB or less, +/−1 dB or less, +/−0.5 dB or less, or otherwise. In some embodiments, the channel bandwidth 212 may be defined by the passband region 218. In other embodiments, the channel bandwidth 212 may be defined as the measured power above a threshold (e.g., dBₜₕ). For example, demultiplexer 206 illustrated in FIG. 2A may optically separate channel N from multi-channel optical signal 110 and have a corresponding channel bandwidth for channel N equivalent to the range of wavelengths above a threshold value that are transmitted to the output region 204 mapped to channel N (i.e., λ_{N}). In the same or other embodiments, isolation of the channel (i.e., defined by channel bandwidth 212) may also be considered when optimizing the design. The isolation may be defined as a ratio between the passband region 218 and the stopband regions (e.g., regions less than SB₁ and greater than SB₂). It is further appreciated that transition band regions (e.g., a first transition region between SB₁ and PB₁ and a second transition region between PB₂ and SB₂) are exemplary and may be exaggerated for the purposes of illustration. In some embodiments, optimization of the design of the photonic demultiplexer may also include a target metric for a slope, width, or the like of the transition band regions.

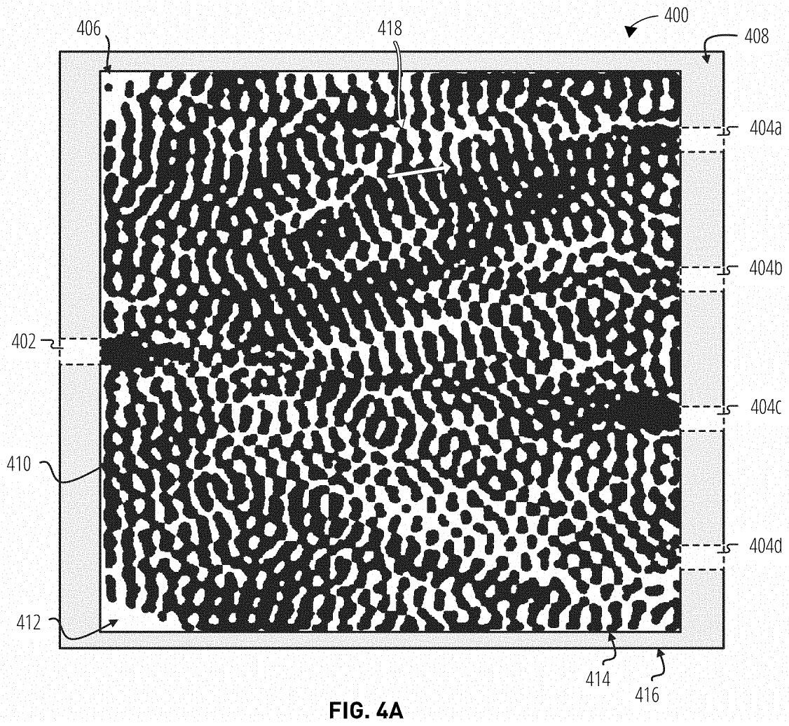

FIG. 3A-FIG. 3D illustrate different views of an example photonic demultiplexer, in accordance with an embodiment of the present disclosure. Photonic demultiplexer 316 is one possible implementation of MUX/DEMUX 114 illustrated in FIG. 1 and demultiplexer 206 illustrated in FIG. 2A. It is further appreciated that while discussion henceforth may be directed towards photonic integrated circuits capable of demultiplexing a plurality of distinct wavelength channels from a multi-channel optical signal, that in other embodiments, a demultiplexer (e.g., demultiplexer 316) may also or alternatively be capable of multiplexing a plurality of distinct wavelength channels into a multi-channel optical signal, in accordance with embodiments of the present disclosure.

FIG. 3A illustrates a cross-sectional view of demultiplexer 316 along a lateral plane within an active layer defined by a width 320 and a length 322 of the demultiplexer 316. As illustrated, demultiplexer 316 includes an input region 302 (e.g., comparable to input region 202 illustrated in FIG. 2A), a plurality of output regions 304 (e.g., comparable to plurality of output regions 204 illustrated in FIG. 2A), and a dispersive region optically disposed between the input region 302 and plurality of output regions 304. The input region 302 and plurality of output regions 304 (e.g., output region 308, output region 310, output region 312, and output region 314) may each be waveguides (e.g., slab waveguide, strip waveguide, slot waveguide, or the like) capable of propagating light along the path of the waveguide. The dispersive region 332 includes a first material and a second material (see, e.g., FIG. 3D) inhomogeneously interspersed to form a plurality of interfaces that each correspond to a change in refractive index of the dispersive region 332 and collectively structure the dispersive region 332 to optically separate each of a plurality of distinct wavelength channels (e.g., Ch. 1, Ch. 2, Ch. 3, . . . Ch. N illustrated in FIG. 2A) from a multi-channel optical signal (e.g., optical signal 110 illustrated in FIG. 2A) and respectively guide each of the plurality of distinct wavelength channels to a corresponding one of the plurality of output regions 304 when the input region 302 receives the multi-channel optical signal. In other words, input region 302 is adapted to receive the multi-channel optical signal including a plurality of distinct wavelength channels and the plurality of output regions 304 are adapted to each receive a corresponding one of the plurality of distinct wavelength channels demultiplexed from the multi-channel optical signal via dispersive region 332.

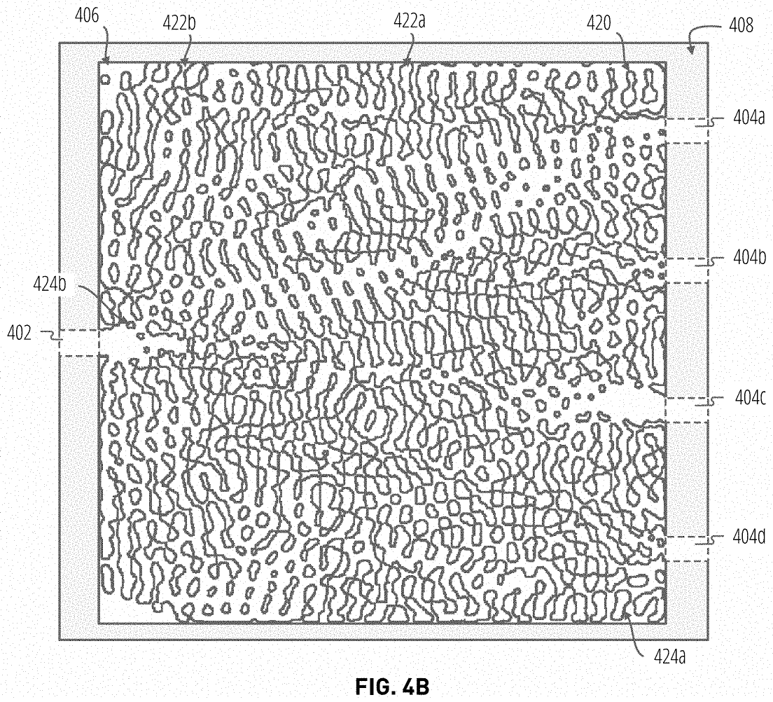

As illustrated in FIG. 3A, and more clearly shown in FIG. 3D and FIG. 4A-FIG. 4B, the shape and arrangement of the first and second material that are inhomogeneously interspersed create a plurality of interfaces that collectively form a material interface pattern along a cross-sectional area of dispersive region 332 that is at least partially surrounded by a periphery region 318 that includes the second material. In some embodiments periphery region 318 has a substantially homogeneous composition that includes the second material. In the illustrated embodiment, dispersive region 332 includes a first side 328 and a second side 330 that each interface with an inner boundary (i.e., the unlabeled dashed line of periphery region 318 disposed between dispersive region 332 and dashed-dotted line corresponding to an outer boundary of periphery region 318). First side 328 and second side 330 are disposed correspond to opposing sides of dispersive region 332. Input region 302 is disposed proximate to first side 328 (e.g., one side of input region 302 abuts first side 328 of dispersive region 332) while each of the plurality of output region 304 are disposed proximate to second side 330 (e.g., one side of each of the plurality of output region 304 abuts second side 330 of dispersive region 332).

In the illustrated embodiment each of the plurality of output regions 304 are parallel to each other one of the plurality of output region 304. However, in other embodiments the plurality of output regions 304 may not be parallel to one another or even disposed on the same side (e.g., one or more of the plurality of output regions 304 and/or input region 302 may be disposed proximate to sides of dispersive region 332 that are adjacent to first side 328 and/or second side 330). In some embodiments adjacent ones of the plurality of output regions are separated from each other by a common separation distance when the plurality of output regions includes at least three output regions. For example, as illustrated adjacent output region 308 and output region 310 are separated from one another by distance 306, which may be common to the separation distance between other pairs of adjacent output regions.

As illustrated in the embodiment of FIG. 3A, demultiplexer 316 includes four output regions 304 (e.g., output region 308, output region 310, output region 312, output region 314) that are each respectively mapped (i.e., by virtue of the structure of dispersive region 332) to a respective one of four channels included in a plurality of distinct wavelength channels. More specifically, the plurality of interfaces of dispersive region 332, defined by the inhomogeneous interspersion of a first material and a second material, form a material interface pattern along a cross-sectional area of the dispersive region 332 (e.g., as illustrated in FIG. 3A, FIG. 4A, or FIG. 4B) to cause the dispersive region 332 to optically separate each of the four channels from the multi-channel optical signal and route each of the four channels to a respective one of the four output regions 304 when the input region 302 regions the multi-channel optical signal.

It is noted that the first material and second material of dispersive region 332 are arranged and shaped within the dispersive region such that the material interface pattern is substantially proportional to a design obtainable with an inverse design process, which will be discussed in greater detail later in the present disclosure. More specifically, in some embodiments, the inverse design process may include iterative gradient-based optimization of a design based at least in part on a loss function that incorporates a performance loss (e.g., to enforce functionality) and a fabrication loss (e.g., to enforce fabric ability and binarization of a first material and a second material) that is reduced or otherwise adjusted via iterative gradient-based optimization to generate the design. In the same or other embodiments, other optimization techniques may be used instead of, or jointly with, gradient-based optimization. Advantageously, this allows for optimization of a near unlimited number of design parameters to achieve functionality and performance within a predetermined area that may not have been possible with conventional design techniques.

For example, in one embodiment dispersive region 332 is structured to optically separate each of the four channels from the multi-channel optical signal within a predetermined area of 35 μm×35 μm (e.g., as defined by width 324 and length 326 of dispersive region 332) when the input region 302 receives the multi-channel optical signal. In the same or another embodiment, the dispersive region is structured to accommodate a common bandwidth for each of the four channels, each of the four channels having different center wavelengths. In one embodiment the common bandwidth is approximately 13 nm wide and the different center wavelengths is selected from a group consisting of 1271 nm, 1291 nm, 1311 nm, 1331 nm, 1506 nm, 1514 nm, 1551 nm, and 1571 nm. In some embodiments, the entire structure of demultiplexer 316 (e.g., including input region 302, periphery region 318, dispersive region 332, and plurality of output regions 304) fits within a predetermined area (e.g., as defined by width 320 and length 322). In one embodiment the predetermined area is 35 μm×35 μm. It is appreciated that in other embodiments dispersive region 332 and/or demultiplexer 316 fits within other areas greater than or less than 35 μm×35 μm, which may result in changes to the structure of dispersive region 332 (e.g., the arrangement and shape of the first and second material) and/or other components of demultiplexer 316.

In the same or other embodiments the dispersive region is structured to have a power transmission of −2 dB or greater from the input region 302, through the dispersive region 332, and to the corresponding one of the plurality of output regions 304 for a given wavelength within one of the plurality of distinct wavelength channels. For example, if channel 1 of a multi-channel optical signal is mapped to output region 308, then when demultiplexer 316 receives the multi-channel optical signal at input region 302 the dispersive region 332 will optically separate channel 1 from the multi-channel optical signal and guide a portion of the multi-channel optical signal corresponding to channel 1 to output region 308 with a power transmission of −2 dB or greater. In the same or another embodiment, dispersive region 332 is structured such that an adverse power transmission (i.e., isolation) for the given wavelength from the input region to any of the plurality of output regions other than the corresponding one of the plurality of output regions is −30 dB or less, −22 dB or less, or otherwise. For example, if channel 1 of a multi-channel optical signal is mapped to output region 308, then the adverse power transmission from input region 302 to any other one of the plurality of output regions (e.g., output region 310, output region 312, output region 314) other than the corresponding one of the plurality of output regions (e.g., output region 308) is −30 dB or less, −22 dB or less, or otherwise. In some embodiments, a maximum power reflection from demultiplexer 316 of an input signal (e.g., a multi-channel optical signal) received at an input region (e.g., input region 302) is reflected back to the input region by dispersive region 332 or otherwise is −40 dB or less, −20 dB or less, −8 dB or less, or otherwise. It is appreciated that in other embodiments the power transmission, adverse power transmission, maximum power, or other performance characteristics may be different than the respective values discussed herein, but the structure of dispersive region 332 may change due to the intrinsic relationship between structure, functionality, and performance of demultiplexer 316.

FIG. 3B illustrates a vertical schematic or stack of various layers that are included in the illustrated embodiment of demultiplexer 316. However, it is appreciated that the illustrated embodiment is not exhaustive and that certain features or elements may be omitted to avoid obscuring certain aspects of the invention. In the illustrated embodiment, demultiplexer 316 includes substrate 334, dielectric layer 336, active layer 338 (e.g., as shown in the cross-sectional illustration of FIG. 3A), and a cladding layer 340. In some embodiments, demultiplexer 316 may be, in part or otherwise, a photonic integrated circuit or silicon photonic device that is compatible with conventional fabrication techniques (e.g., lithographic techniques such as photolithographic, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 334, a silicon dioxide dielectric layer that corresponds to dielectric layer 336, a silicon layer (e.g., intrinsic, doped, or otherwise), and a oxide layer (e.g., intrinsic, grown, or otherwise). In one embodiment, the silicon in the active layer 338 may be etched selectively by lithographically creating a pattern on the SOI wafer that is transferred to SOI wafer via a dry etch process (e.g., via a photoresist mask or other hard mask) to remove portions of the silicon. The silicon may be etched all the way down to dielectric layer 336 to form voids that may subsequently be backfilled with silicon dioxide that is subsequently encapsulated with silicon dioxide to form cladding layer 340. In one embodiment, there may be several etch depths including a full etch depth of the silicon to obtain the targeted structure. In one embodiment, the silicon may be 206 nm thick and thus the full etch depth may be 206 nm. In some embodiments, this may be a two-step encapsulation process in which two silicon dioxide depositions are performed with an intermediate chemical mechanical planarization used to yield a planar surface.

FIG. 3C illustrates a more detailed view of active layer 338 (relative to FIG. 3B) taken along a portion of periphery region 318 that includes input region 302 of FIG. 3A. In the illustrated embodiment, active layer 338 includes a first material 342 with a refractive index of ε₁ and a second material 344 with a refractive index of ε₂ that is different from ε₁. Homogenous regions of the first material 342 and the second material 344 may form waveguides or portions of waveguides that correspond to input region 302 and plurality of output region 304 as illustrated in FIG. 3A and FIG. 3C.

FIG. 3D illustrates a more detailed view of active layer 338 (relative to FIG. 3B) taken along dispersive region 332. As described previously, active layer 338 includes a first material 342 (e.g., silicon) and a second material 344 (e.g., silicon dioxide) that are inhomogeneously interspersed to form a plurality of interfaces 346 that collectively form a material interface pattern. Each of the plurality of interfaces 346 that form the interface pattern correspond to a change in refractive index of dispersive region 332 to structure the dispersive region (i.e., the shape and arrangement of first material 342 and second material 344) to provide, at least in part, the functionality of demultiplexer 316 (i.e., optical separation of the plurality of distinct wavelength channels from the multi-channel optical signal and respective guidance of each of the plurality of distinct wavelength channels to the corresponding one of the plurality of output regions 304 when the input region 302 receives the multi-channel optical signal).

It is appreciated that in the illustrated embodiments of demultiplexer 316 as shown in FIG. 3A-FIG. 3D, the change in refractive index is shown as being vertically consistent (i.e., the first material 342 and second material 344 form interfaces that are substantially vertical or perpendicular to a lateral plane or cross-section of demultiplexer 316. However, in the same or other embodiments, the plurality of interfaces (e.g., interfaces 346 illustrated in FIG. 3D) may not be substantially perpendicular with the lateral plane or cross-section of demultiplexer 316.

FIG. 4A illustrates a more detailed cross-sectional view of a dispersive region of example photonic demultiplexer 400, in accordance with an embodiment of the present disclosure. FIG. 4B illustrates a more detailed view of an interface pattern formed by the shape and arrangement of a first material 410 and a second material 412 for the dispersive region of the photonic demultiplexer 400 of FIG. 4A. Photonic demultiplexer 400 is one possible implementation of MUX/DEMUX 114 illustrated in FIG. 1, demultiplexer 206 illustrated in FIG. 2A, and demultiplexer 316 illustrated in FIG. 3A-FIG. 3D.

As illustrated in FIG. 4A and FIG. 4B, photonic demultiplexer 400 includes an input region 402, a plurality of output regions 404a-404d, and a dispersive region 406 optically disposed between input region 402 and plurality of output regions 404a-404d. Dispersive region 406 is surrounded, at least in part, by a peripheral region 408 that includes an inner boundary 414 and an outer boundary 416. It is appreciated that like named or labeled elements of photonic demultiplexer 400 may similarly correspond to like named or labeled elements of other demultiplexers described in embodiments of the present disclosure.

The first material 410 (i.e., black colored regions within dispersive region 406) and second material 412 (i.e., white colored regions within dispersive region 406) of photonic demultiplexer 400 are inhomogeneously interspersed to create a plurality of interfaces that collectively form material interface pattern 420 as illustrated in FIG. 4B. More specifically, an inverse design process that utilizes iterative gradient-based optimization, Markov Chain Monte Carlo optimization, or other optimization techniques combined with first principles simulations to generate a design that is substantially replicated by dispersive region 406 within a proportional or scaled manner such that photonic demultiplexer 400 provides the desired functionality. In the illustrated embodiment, dispersive region 406 is structured to optically separate each of a plurality of distinct wavelength channels from a multi-channel optical signal and respectively guide each of the plurality of distinct wavelength channels to a corresponding one of the plurality of output regions 404a-404d when the input region 402 receives the multi-channel optical signal. More specifically, the plurality of output regions 404a-404d are respectively mapped to wavelength channels having center wavelengths correspond to 1271 nm, 1291 nm, 1311 nm, and 1331 nm. In another embodiment, output regions 404a-404d are respectfully mapped to wavelength channels having center wavelengths that correspond to 1506 nm, 1514 nm, 1551 nm, and 1571 nm.

As illustrated in FIG. 4B, material interface pattern 420, which is defined by the black lines within dispersive region 406 and corresponds to a change in refractive index within dispersive region 406, includes a plurality of protrusions 422a-422b. A first protrusion 422a is formed of the first material 410 and extends from peripheral region 408 into dispersive region 406. Similarly, a second protrusion 422b is formed of the second material 412 and extends from peripheral region 408 into dispersive region 406. Further illustrated in FIG. 4B, dispersive region 406 includes a plurality of islands 424a-424b formed of either the first material 410 or the second material 412. The plurality of islands 424a-424b include a first island 424a that is formed of the first material 410 and is surrounded by the second material 412. The plurality of islands 424a-424b also includes a second island 424b that is formed of the second material 412 and is surrounded by the first material 410.

In some embodiments, material interface pattern 420 includes one or more dendritic shapes, wherein each of the one or more dendritic shapes are defined as a branched structure formed from first material 410 or second material 412 and having a width that alternates between increasing and decreasing in size along a corresponding direction. Referring back to FIG. 4A, for clarity, dendritic structure 418 is labeled with a white arrow having a black border. As can be seen, the width of dendritic structure 418 alternatively increases and decreases in size along a corresponding direction (i.e., the white labeled arrow overlaying a length of dendritic structure 418) to create a branched structure. It is appreciated that in other embodiments there may be no protrusions, there may be no islands, there may be no dendritic structures, or there may be any number, including zero, of protrusions, islands of any material included in the dispersive region 406, dendritic structures, or a combination thereof.

In some embodiments, the inverse design process includes a fabrication loss that enforces a minimum feature size, for example, to ensure fabricability of the design. In the illustrated embodiment of photonic demultiplexer 400 illustrated in FIG. 4A and FIG. 4B, material interface pattern 420 is shaped to enforce a minimum feature size within dispersive region 406 such that the plurality of interfaces within the cross-sectional area formed with first material 410 and second material 412 do not have a radius of curvature with a magnitude of less than a threshold size. For example, if the minimum feature size is 150 nm, the radius of curvature for any of the plurality of interfaces have a magnitude of less than the threshold size, which corresponds the inverse of half the minimum feature size (i.e., 1/75 nm⁻¹). Enforcement of such a minimum feature size prevents the inverse design process from generating designs that are not fabricable by considering manufacturing constraints, limitations, and/or yield. In the same or other embodiments, different or additional checks on metrics related to fabricability may be utilized to enforce a minimum width or spacing as a minimum feature size.

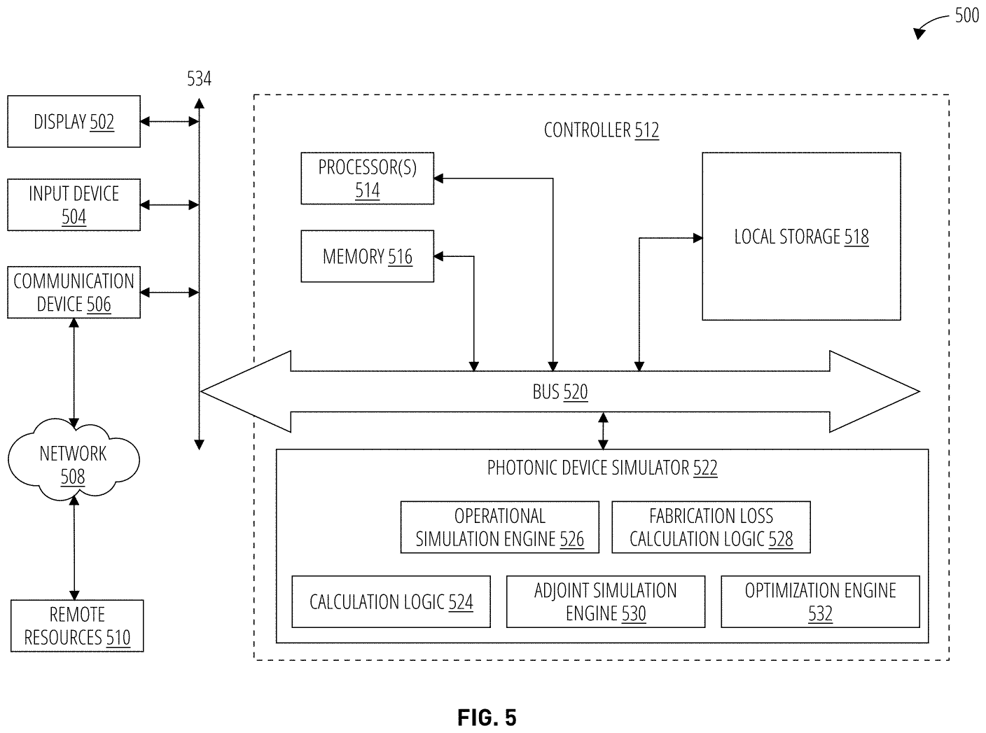

FIG. 5 is a functional block diagram illustrating a system 500 for generating a design of a photonic integrated circuit (i.e., photonic device), in accordance with an embodiment of the disclosure. System 500 may be utilized to perform an inverse design process that generates a design with iterative gradient-based optimization that takes into consideration the underlying physics that govern the operation of the photonic integrated circuit. More specifically, system 500 is a design tool that may be utilized to optimize structural parameters (e.g., shape and arrangement of a first material and a second material within the dispersive region of the embodiments described in the present disclosure) of photonic integrated circuits based on first-principles simulations (e.g., electromagnetic simulations to determine a field response of the photonic device to an excitation source) and iterative gradient-based optimization. In other words, system 500 may provide a design obtained via the inverse design process that is substantially replicated (i.e., proportionally scaled) by dispersive region 332 and dispersive region 406 of demultiplexer 316 and photonic demultiplexer 400 illustrated in FIG. 3A and FIG. 4A, respectively.

As illustrated, system 500 includes controller 512, display 502, input device(s) 504, communication device(s) 506, network 508, remote resources 510, bus 534, and bus 520. Controller 512 includes processor 514, memory 516, local storage 518, and photonic device simulator 522. Photonic device simulator 522 includes operational simulation engine 526, fabrication loss calculation logic 528, calculation logic 524, adjoint simulation engine 530, and optimization engine 532. It is appreciated that in some embodiments, controller 512 may be a distributed system.

Controller 512 is coupled to display 502 (e.g., a light emitting diode display, a liquid crystal display, and the like) coupled to bus 534 through bus 520 for displaying information to a user utilizing system 500 to optimize structural parameters of the photonic device (i.e., demultiplexer). Input device 504 is coupled to bus 534 through bus 520 for communicating information and command selections to processor 514. Input device 504 may include a mouse, trackball, keyboard, stylus, or other computer peripheral, to facilitate an interaction between the user and controller 512. In response, controller 512 may provide verification of the interaction through display 502.

Another device, which may optionally be coupled to controller 512, is one or more communication device(s) 506 for accessing remote resources 510 of a distributed system via network 508. Communication device 506 may include any of a number of networking peripheral devices such as those used for coupling to an Ethernet, Internet, or wide area network, and the like. Communication device 506 may further include a mechanism that provides connectivity between controller 512 and the outside world. Note that any or all of the components of system 500 illustrated in FIG. 5 and associated hardware may be used in various embodiments of the present disclosure. The remote resources 510 may be part of a distributed system and include any number of processors, memory, and other resources for optimizing the structural parameters of the photonic device.

Controller 512 orchestrates operation of system 500 for optimizing structural parameters of the photonic device. Processor 514 (e.g., one or more central processing units, graphics processing units, and/or tensor processing units, etc.), memory 516 (e.g., volatile memory such as DRAM and SRAM, non-volatile memory such as ROM, flash memory, and the like), local storage 518 (e.g., magnetic memory such as computer disk drives), and the photonic device simulator 522 are coupled to each other through bus 520. Controller 512 includes software (e.g., instructions included in memory 516 coupled to processor 514) and/or hardware logic (e.g., application specific integrated circuits, field-programmable gate arrays, and the like) that when executed by controller 512 causes controller 512 or system 500 to perform operations. The operations may be based on instructions stored within any one of, or a combination of, memory 516, local storage 518, physical device simulator 522, and remote resources 510 accessed through network 508.

In the illustrated embodiment, the components of photonic device simulator 522 are utilized to optimize structural parameters of the photonic device (e.g., MUX/DEMUX 114 of FIG. 1, demultiplexer 206 of FIG. 2A, multiplexer 208 of FIG. 2B, demultiplexer 316 of FIG. 3A-FIG. 3D, and photonic demultiplexer 400 of FIG. 4A-FIG. 4B). In some embodiments, system 500 may optimize the structural parameters of the photonic device via, inter alia, simulations (e.g., operational and adjoint simulations) that utilize a finite-difference time-domain (FDTD) method, a finite-difference frequency-domain (FDFD) method, or any other suitable technique to model the field response (e.g., electric and magnetic fields within the photonic device). The operational simulation engine 526 provides instructions for performing an electromagnetic simulation of the photonic device operating in response to an excitation source within a virtual prototype. In particular, the operational simulation determines a field response of the virtual prototype (and thus the photonic device, which is described by the virtual prototype) in response to the excitation source for determining a performance metric of the physical device (e.g., based off an initial description or input design of the photonic device that describes the structural parameters of the photonic device within the virtual prototype with a plurality of voxels). The structural parameters may correspond, for example, to the specific design, material compositions, dimensions, and the like of the physical device. Fabrication loss calculation logic 528 provides instructions for determining a fabrication loss, which is utilized to enforce a minimum feature size to ensure fabricability. In some embodiments, the fabrication loss is also used to enforce binarization of the design (i.e., such that the photonic device includes a first material and a second material that are interspersed to form a plurality of interfaces). Calculation logic 524 computes a loss metric determined via a loss function that incorporates a performance loss, based on the performance metric, and the fabrication loss. Adjoint simulation engine 530 is utilized in conjunction with the operational simulation engine 526 to perform an adjoint simulation of the photonic device to backpropagate the loss metric through the virtual prototype via the loss function to determine how changes in the structural parameters of the photonic device influence the loss metric (i.e., the gradient of the loss function with respect to the structural parameters, otherwise known as a sensitivity map). Optimization engine 532 is utilized to update the structural parameters of the photonic device to reduce the loss metric and generate a revised description (i.e., revising the design) of the photonic device.

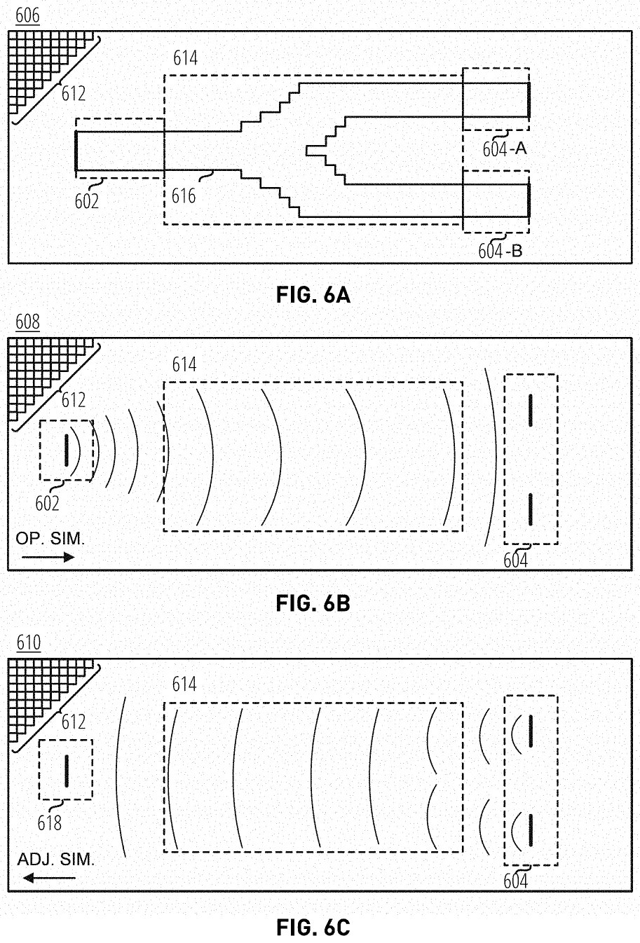

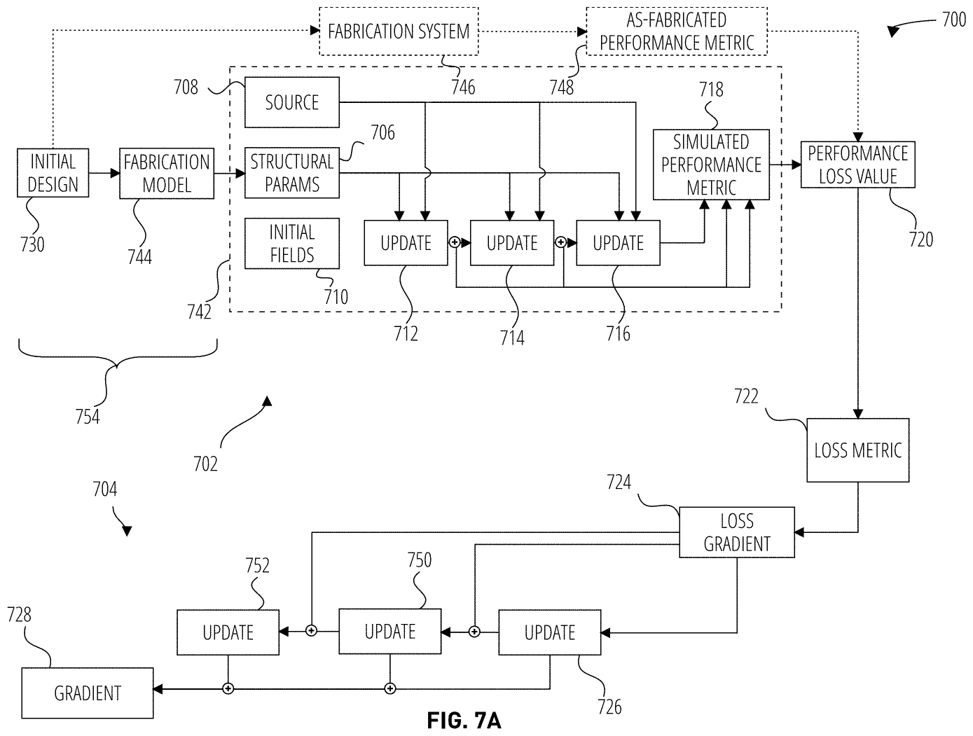

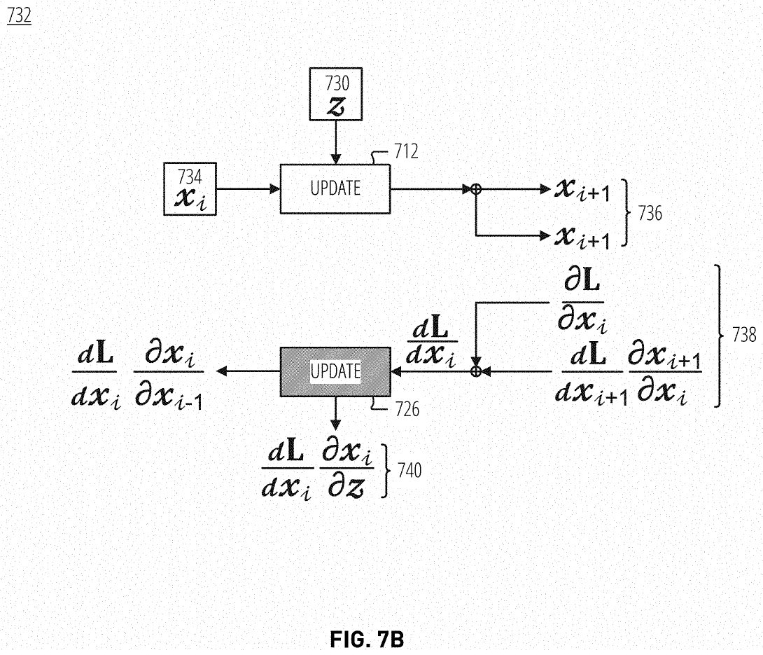

FIG. 6A-FIG. 6C respectively illustrate non-limiting example embodiments of an initial set up of a virtual prototype 606 describing a photonic device, performing an operational simulation of the photonic device in response to an excitation source within the virtual prototype 608, and performing an adjoint simulation of the photonic device within the virtual prototype 610 according to various aspects of the present disclosure. The initial set up of the virtual prototype, 1-dimensional representation of the virtual prototype, operational simulation of the physical device, and adjoint simulation of the physical device may be implemented with system 500 illustrated in FIG. 5.

As illustrated in FIG. 6A-FIG. 6C, the virtual prototype is represented in two dimensions. However, it is appreciated that other dimensionality (e.g., 3-dimensional space) may also be used to describe the virtual prototype and the photonic device. In some embodiments, optimization of structural parameters of the photonic device illustrated in FIG. 6A-FIG. 6C may be achieved via an inverse design process including, inter alia, simulations (e.g., operational simulations and adjoint simulations) that utilize a finite-difference time-domain (FDTD) method, a finite-difference frequency-domain (FDFD) method, or any other suitable technique to model the field response (e.g., electric and magnetic field) to an excitation source.

FIG. 6A illustrates a demonstrative virtual prototype 606 describing a photonic integrated circuit (i.e., a photonic device such as a waveguide, demultiplexer, and the like), in accordance with a non-limiting example embodiment of the present disclosure. More specifically, in response to receiving an initial description of a photonic device defined by one or more structural parameters (e.g., an input design), a system (e.g., system 500 of FIG. 5) configures a virtual prototype 606 to be representative of the photonic device. As illustrated, the virtual prototype 606 (and subsequently the photonic device) is described by a plurality of voxels 612, which represent individual elements (i.e., discretized) of the two-dimensional (or other dimensionality) space. Each of the voxels 612 is illustrated as a two-dimensional square; however, it is appreciated that the voxel may be represented as cubes or other shapes in three-dimensional space. It is appreciated that the specific shape and dimensionality of the plurality of voxels 612 may be adjusted dependent on the virtual prototype 606 and photonic device being simulated. It is further noted that only a portion of the plurality of voxels 612 are illustrated to avoid obscuring other aspects of the virtual prototype 606.

Each of the plurality of voxels 612 may be associated with a structural value, a field value, and a source value. Collectively, the structural values of the virtual prototype 606 describe the structural parameters of the photonic device. In one embodiment, the structural values may correspond to a relative permittivity, permeability, and/or refractive index that collectively describe structural (i.e., material) boundaries or interfaces of the photonic device (e.g., material interface pattern 420 of FIG. 4B). For example, an interface 616 is representative of where relative permittivity changes within the virtual prototype 606 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxels 612. Thus, the field response may be based, at least in part, on the structural parameters of the photonic device and the excitation source.

In the illustrated embodiment, the photonic device corresponds to an optical demultiplexer having a design region 614 (e.g., corresponding to dispersive region 332 of FIG. 3A, and/or dispersive region 406 of FIG. 4A), in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 602 to a corresponding one of the output ports 604. Thus, input port 602 (e.g., corresponding to input region 302 of FIG. 3A, input region 402 of FIG. 4A, and the like) of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within virtual prototype 606). In other words, the excitation source may cause the field response of the photonic device to change, which is dependent on the underlying physics governing the physical domain and the structural parameters of the photonic device. The excitation source originates or is otherwise proximate to input port 602 and is positioned to propagate (or otherwise influence the field value of the plurality of voxel) through the design region 614 towards output ports 604 of the photonic device. In the illustrated embodiment, the input port 602 and output ports 604 are positioned outside of the design region 614. In other words, in the illustrated embodiment, only a portion of the structural parameters of the photonic device is optimizable.

However, in other embodiments, the entirety of the photonic device may be placed within the design region 614 such that the structural parameters may represent any portion or the entirety of the design of the photonic device. The electric and magnetic fields within the virtual prototype 606 (and subsequently the photonic device) may change (e.g., represented by the field value of the individual voxel that collectively correspond to the field response of the virtual prototype) in response to the excitation source. The output ports 604 of the optical demultiplexer may be used for determining a performance metric of the photonic device in response to the excitation source (e.g., power transmission from input port 602 to a specific one of the output ports 604). The initial description of the photonic device, including initial structural parameters, excitation sources, performance parameters or metrics, and other parameters describing the photonic device, are received by the system (e.g., system 500 of FIG. 5) and used to configure the virtual prototype 606 for performing a first-principles based simulation of the photonic device. These specific values and parameters may be defined directly by a user (e.g., of system 500 in FIG. 5), indirectly (e.g., via controller 512 culling pre-determined values stored in memory 516, local storage 518, or remote resources 510), or a combination thereof.

FIG. 6B illustrates a non-limiting example embodiment of an operational simulation of the photonic device in response to an excitation source within the virtual prototype 608, in accordance with various aspects of the present disclosure. In the illustrated embodiment, the photonic device is an optical demultiplexer structured to optically separate each of a plurality of distinct wavelength channels included in a multi-channel optical signal received at input port 602 and respectively guide each of the plurality of distinct wavelength channels to a corresponding one of the plurality of output ports 604. The excitation source may be selected (randomly or otherwise) from the plurality of distinct wavelength channels and originates at input port 602 having a specified spatial, phase, and/or temporal profile. The operational simulation occurs over a plurality of time steps, including the illustrated time step. When performing the operational simulation, changes to the field response (e.g., the field value) for each of the plurality of voxels 612 are incrementally updated in response to the excitation source over the plurality of time steps. The changes in the field response at a particular time step are based, at least in part, on the structural parameters, the excitation source, and the field response of the virtual prototype 610 at the immediately prior time step included in the plurality of time steps. Similarly, in some embodiments the source value of the plurality of voxels 612 is updated (e.g., based on the spatial profile and/or temporal profile describing the excitation source). It is appreciated that the operational simulation is incremental and that the field values (and source values) of the virtual prototype 610 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In one embodiment, the performance metric corresponds to the power transmission at a corresponding one of the output ports 604 mapped to the distinct wavelength channel being simulated by the excitation source. In other words, in some embodiments, the performance metric represents power (at one or more frequencies of interest) in the target mode shape at the specific locations of the output ports 604. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric may be further based on a fabrication loss value that is utilized to enforce a minimum feature size of the photonic device to promote fabricability of the device, and/or other loss values.

FIG. 6C illustrates a non-limiting example embodiment of an adjoint simulation within the virtual prototype 610 by backpropagating a loss metric, in accordance with various aspects of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 604) or other location that corresponds to a location used when determining the performance metric. The adjoint source(s) is then treated as a physical stimuli or an excitation source during the adjoint simulation. A loss response of the virtual prototype 608 is computed for each of the plurality of time steps (e.g., backwards in time) in response to the adjoint source. The loss response collectively refers to loss values of the plurality of voxels 612 that are incrementally updated in response to the adjoint source over the plurality of time steps. The change in loss response based on the loss metric may correspond to a loss gradient, which is indicative of how changes in the field response of the physical device influence the loss metric. The fields computed in response to the adjoint source are combined with the fields from the operational simulation to obtain a structural gradient of the photonic device/virtual prototype (e.g., how changes in the structural parameters of the photonic device within the virtual prototype influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performed while maintaining fabricability.

One problem in designing physical devices such as the photonic devices described above is that fabrication systems generally do not produce photonic devices that have the precise structure that is simulated using the techniques described above. The fabrication of photonic devices using fabrication systems such as semiconductor foundries involves a complex, multi-stage process of transferring the design from a photomask to a silicon wafer. Despite pre-corrections made to the photomask to compensate for distortion effects introduced by the photolithography process, the fabricated physical device still may exhibit shape distortions including but not limited to rounding of sharp corners, erosion or dilation of shape contours, oblique sidewall angles, and non-uniform layer thicknesses. These distortions are due to statistical variations of semiconductor processing and can affect performance of the manufactured physical devices in unexpected ways, given the delicate wave-interference physics which underlies the performance of physical devices such as the photonic devices described herein.

Characterizing these non-uniformities is a priority for operators of fabrication systems and typically requires a large sample of wafer runs. A process design kit (PDK) provided by a given fabrication system/foundry typically includes specifications and tolerances for critical features sizes such as the minimum line width and spacing, curvature, as well as minimum area (e.g, islands) and enclosed area (e.g., holes). However, the detailed processing capability including the optical proximity correction (OPC) and yields of a given foundry node are trade secrets, and are not generally available during the design process of the physical device to be fabricated. To ensure reliable and consistent manufacturing of inverse-designed physical devices, it is desirable to know a priori what the manufactured structure in the silicon wafer will be for a given photomask/design. It is further desirable for this information to be available without any detailed knowledge of the capabilities of the fabrication system beyond what is made publicly available (e.g., as part of the PDK).

One approach to generating a foundry-fabrication model is to take a scanning electron microscope (SEM) image or processing-simulation-generated prototype of the fabricated structure and come up with a series of differentiable operations (i.e., convolutions/filters, projections/thresholds, etc.) which can be applied sequentially to transform the photomask design to the image/prototype. Each of these individual operations is parameterized by some degrees of freedom and the problem is to determine these unknowns using gradient-based optimization via reverse-mode automatic differentiation of a scalar loss function. The transformation function can have an arbitrary number of parameters in order to incorporate the equivalent of the combined effects of the foundry OPC and processing.

Generally, it is challenging to generate a large set of input data using SEM images or simulated prototypes for training the foundry-fabrication model. There are three main challenges with this approach in which the inputs to the fabrication model are the photomask design and either SEM images or prototypes of the fabricated device:
1. Obtaining SEM images of the fabricated structure requires manual post processing of the silicon wafer which is time consuming and expensive. Also, large-area devices (e.g., Bragg grating couplers, ring resonators, etc.) which cannot fit into the microscope's field of view require stitching together multiple separate images. When taking SEM images at high resolutions, individual images typically show non-uniform image contrast because the chip tends not to be mounted perfectly flat on the microscope stage.
2. Given the 2D representation of the SEM image or simulation prototype, the loss function takes as input the shape contours from a planar cross section of the device, and the actual 3D topology is generally ignored. As a result, there is an incomplete characterization of the overall device structure and potentially important features affecting device performance such as layer thickness nonuniformities, oblique surface sidewall angle, surface roughness, etc. are excluded from the analysis.
3. The process simulations used to generate prototypes depend on proprietary input related to the manufacturing capabilities and tooling specifications of the foundry which may not be readily shared with third parties.

What is desired are design techniques that can accurately model fabrication processes within fabrication systems without requiring proprietary information regarding the manufacturing process in order to increase the performance of the designed physical devices.

In some embodiments of the present disclosure, a new approach to creating a fabrication model for modeling the foundry-fabrication process is based on combining optical measurements of the fabricated device with topology optimization and full-wave electromagnetic simulations. In some embodiments, these techniques start by determining a photomask design and then using topology optimization to evolve the initial 3D structure based on the 2D photomask design until its simulated performance matches experimental measurements of an as-fabricated design. Similar to the SEM image/prototype-based approach described above, the optimization problem involves finding a set of parameters of a sequence of differentiable operations which minimize, for example, a difference of the simulated performance of the virtual prototype and the measured optical response of an as-fabricated design (e.g., minimizing a mean-squared error over a set of frequencies). This approach can use the same or a similar topology optimization framework that was initially used to design the photomask to match a pre-specified target output. Because the technique starts with a known initial design and is applying a similar set of constraints in the two stages of topology optimization, the design space is sufficiently limited such that the final design is likely to match the as-fabricated design.

Many benefits arise from using approaches in which the fabrication model is created based on the photomask design and the optical measurement of the fabricated device, including but not limited to the following:
1. No input from the foundry or contract manufacturer is necessary beyond what is provided by their PDK. This input is often not publicly available or shared with third parties due to trade secret protection or other reasons for the foundry/fabrication system not sharing the information.
2. A single 300 mm wafer can provide a testbed of potentially tens of thousands of different structures. This large labeled dataset can be used as the basis for developing and validating an arbitrary transformation function or more generally a neural network, as long as it is differentiable.
3. The output of the fabrication model can still be validated against SEM images of the actual fabricated structures. This provides a mechanism to independently verify the correctness of the foundry fabrication model, but the SEM images are not necessary for determining the fabrication model.

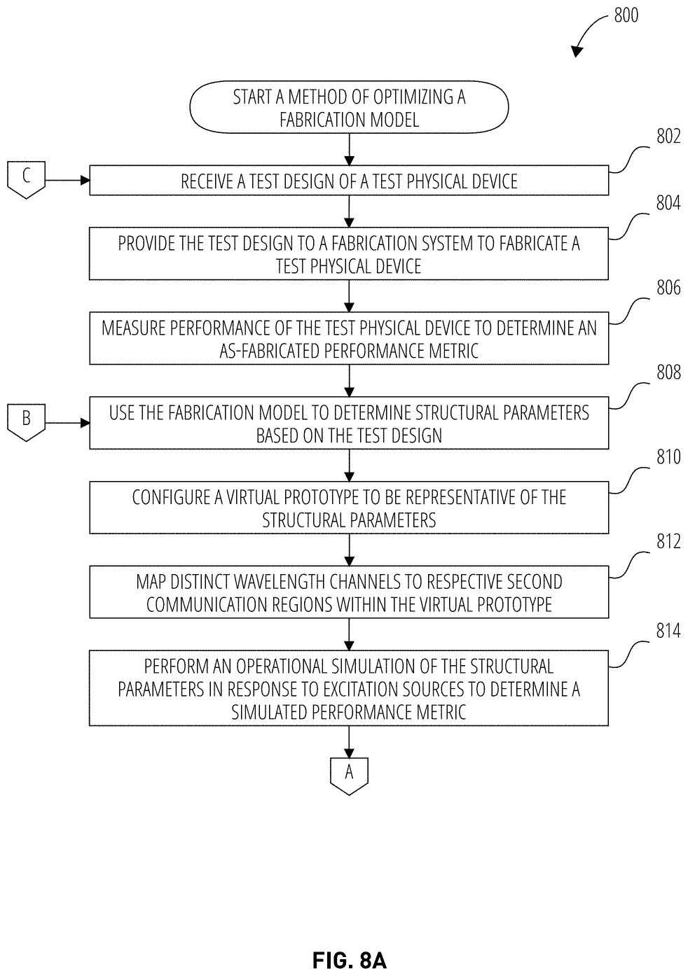

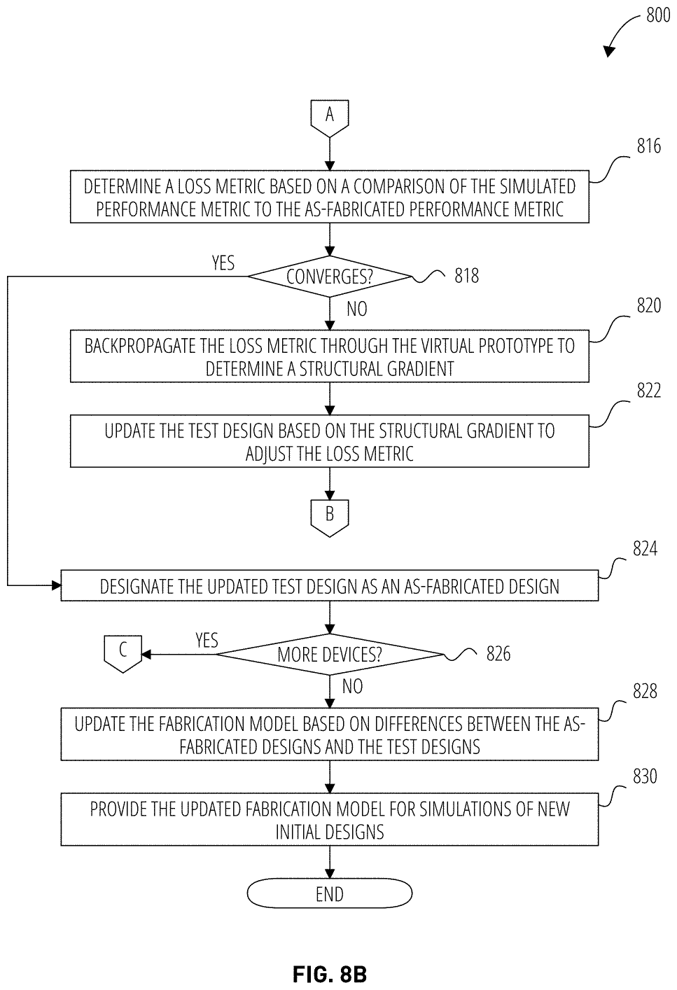

FIG. 7A is a flow chart 700 illustrating example time steps for an operational simulation 702 and an adjoint simulation 704, in accordance with various aspects of the present disclosure. Flow chart 700 is one possible implementation that a system may use to perform the operational simulation 702 and adjoint simulation 704 of the virtual prototype describing a photonic integrated circuit (e.g., an optical device operating in an electromagnetic domain such as a photonic demultiplexer). In the illustrated embodiment, the operational simulation 702 utilizes a technique such as a finite-difference time-domain (FDTD) method to model the field response (both electric and magnetic) or loss response at each of a plurality of voxels for a plurality of time steps in response to physical stimuli corresponding to an excitation source and/or adjoint source. In some embodiments, a fabrication model may be used to improve the accuracy of the simulation, and the fabrication model may be updated using similar operational simulation/adjoint simulation techniques as described in further detail below.

As illustrated in FIG. 7A, the operational simulation 702 includes a configuration portion 754 and a simulation portion 742. In the configuration portion 754, an initial design 730 is received that includes structural parameters for a physical device such as a photonic device to be simulated. In some embodiments, the initial design 730 may also include additional or different information regarding the design, including but not limited to a linear function to define the structural parameters (instead of the structural parameters themselves), desired performance values, a performance loss function to be used to compare simulated performance to desired performance, or other information.

After receiving the initial design 730, the operational simulation 702 uses a fabrication model 744 to simulate the fabrication of the photonic device based on the initial structural parameters to create structural parameters 706 to be simulated in the simulation portion 742. In some embodiments, the fabrication model 744 is a sequence of differentiable operations that embodies differences from the initial design 730 that will be introduced by a fabrication system during fabrication. In some embodiments, instead of a sequence of differentiable operations, the fabrication model 744 may be represented by a neural network. Parameters for the fabrication model 744 may be learned using an optimization process as described in further detail below.

After the structural parameters 706 are determined using the fabrication model 744, the operational simulation 702 proceeds to a simulation portion 742. The simulation portion 742 occurs over a plurality of time-steps (e.g., from an initial time step to a final time step over a pre-determined or conditional number of time steps having a specified time step size) and models changes (e.g., from the initial field value 710) in electric and magnetic fields of a plurality of voxels describing the virtual prototype and/or photonic device that collectively correspond to the field response. More specifically, update operations (e.g., update operation 712, update operation 714, and update operation 716) are iterative and based on the field response, structural parameters 706, and one or more excitation sources 708. Each update operation is succeeded by another update operation, which are representative of successive steps forward in time within the plurality of time steps. For example, update operation 714 updates the field values 734 (see, e.g., FIG. 7B) based on the field response determined from the previous update operation 712, excitation sources 708, and the structural parameters 706. Similarly, update operation 716 updates the field values 736 (see, e.g., FIG. 7B) based on the field response determined from update operation 714. In other words, at each time step of the operational simulation 702 the field values (and thus field response) are updated based on the previous field response and structural parameters of the photonic device.

Once the final time step of the simulation portion 742 is performed (although three update operations are illustrated for the sake of clarity and brevity, in some embodiments more than three update operations are performed), a simulated performance metric 718 is used to determine a performance loss value 720 associated with the structural parameters 706. In some embodiments, the simulated performance metric 718 is a characterization of the performance of the simulated device at one or more points (e.g., at the output ports of the device) and at one or more bandwidths, similar to the illustration in FIG. 2C, and the performance loss value 720 may include a comparison of the simulated performance metric 718 to a desired performance metric. The performance loss value 720 can then be used to determine (or used as) a loss metric 722. In some embodiments, the performance loss value 720 or loss metric 722 may include multiple values for multiple aspects of performance (e.g., for separate output ports).

From the loss metric 722, a loss gradient 724 may be determined. The loss gradient 724 may be treated as adjoint or virtual sources (e.g., physical stimuli or excitation source originating at an output region or port) which are backpropagated in reverse (from the final time step incrementally through the plurality of time steps until reaching the initial time step via update operation 726, update operation 750, and update operation 752) to determine gradient 728. Because it is determined based on the simulated performance metric 718, the gradient 728 is associated with the initial design 730 as modified by the fabrication model 744.

In the illustrated embodiment, the FDTD solve (e.g., simulation portion 742 of the operational simulation 702) and backward solve (e.g., adjoint simulation 704) problem are described pictorially, from a high-level, using only “update” and “loss” operations as well as their corresponding gradient operations. The simulation is set up initially in which the structural parameters, physical stimuli (i.e., excitation sources), and initial field states of the virtual prototype (and photonic device) are provided (e.g., via an initial description and/or input design). As discussed previously, the field values are updated in response to the excitation sources based on the structural parameters. More specifically, the update operation is given by ϕ, where [symbol] =ϕ( [symbol] ) for [symbol] =1, . . . , [symbol] . Here, [symbol] corresponds to the total number of time steps (e.g., the plurality of time steps) for the operational simulation, where [symbol] corresponds to the field response (the field value associated with the electric and magnetic fields of each of the plurality of voxels) of the virtual prototype at time step [symbol] corresponds to the excitation source(s) (the source value associated with the electric and magnetic fields for each of the plurality of voxels) of the virtual prototype at time step [symbol] , and [symbol] corresponds to the structural parameters describing the topology and/or material properties of the physical device (e.g., relative permittivity, index of refraction, and the like).

It is noted that using the FDTD method, the update operation may specifically be stated as:

ϕ( [symbol] )=A( [symbol] ) [symbol] +B( [symbol] )

[symbol]

That is to say the FDTD update is linear with respect to the field and source terms. Concretely, A( [symbol] )∈ [symbol] ^{N×N} and B( [symbol] )∈ [symbol] ^{N×N} are linear operators which depend on the structural parameters, [symbol] , and act on the fields, [symbol] , and the sources, [symbol] , respectively. Here, it is assumed that [symbol] ∈ [symbol] ^{N} where N is the number of FDTD field components in the operational simulation. Additionally, the loss operation (e.g., loss function) may be given by L=ƒ( [symbol] , . . . , [symbol] ), which takes as input the computed fields and produces a single, real-valued scalar (e.g., the loss metric) that can be reduced and/or minimized.

In terms of revising or otherwise optimizing the structural parameters of the physical device, the relevant quantity to produce is

$$\frac{d L}{d z} ,$$

which is used to describe the influence of changes in the structural parameters of the initial design 730 on the loss value and is denoted as the gradient 728 illustrated in FIG. 7A.

FIG. 7B is a chart 732 illustrating the relationship between the update operation for the operational simulation and the adjoint simulation (e.g., backpropagation), in accordance with an embodiment of the present disclosure. More specifically, FIG. 7B summarizes the operational and adjoint simulation relationships that are involved in computing the structural gradient,

$$\frac{d L}{d z} ,$$

which include

$$\frac{\partial L}{\partial {x}_{i}} , \frac{\partial {x}_{i + 1}}{\partial {x}_{i}} , \frac{d L}{d {x}_{i}} , and \frac{\partial {x}_{i}}{\partial z} .$$

The update operation 714 of the operational simulation 702 updates the field value 734, [symbol] , of the plurality of voxels at the ith time step to the next time step (i.e., [symbol] +1 time step), which correspond to the field values 736, [symbol] . The gradient 738 are utilized to determine for the backpropagation (e.g., update operation 726 backwards in time), which combined with the gradient 740 are used, at least in part, to calculate the structural gradient,

$$\frac{d L}{d z} . \frac{\partial L}{\partial {x}_{i}}$$

is the contribution of each field to the loss metric, L. It is noted that this is the partial derivative, and therefore does not take into account the causal relationship of [symbol] → [symbol] . Thus,

$$\frac{\partial {x}_{i + 1}}{\partial {x}_{i}}$$

is utilized which encompasses the [symbol] → [symbol] relationship. The loss gradient,

$$\frac{d L}{d {x}_{i}} ,$$

may also be used to compute the structural gradient,

$$\frac{d L}{d z} ,$$

and corresponds to the total derivative of the field with respect to loss value, L. The loss gradient,

$$\frac{d L}{d {x}_{i}} ,$$

at a particular time step, [symbol] , is equal to the summation of

$$\frac{\partial L}{\partial {x}_{i}} + \frac{d L}{d {x}_{i + 1}} \frac{\partial {x}_{i + 1}}{\partial {x}_{i}} .$$

### Finally,

$$\frac{\partial {x}_{i}}{\partial z} ,$$

which corresponds to the field gradient, is used which is the contribution to

$$\frac{d L}{d z}$$

from each time/update step.

In particular, the memory footprint to directly compute

$$\frac{\partial L}{\partial {x}_{i}} and \frac{d L}{d z}$$

is so large that it is difficult to store more than a handful of state Tensors. The state Tensor corresponds to storing the values of all of the FDTD cells (e.g., the plurality of voxels) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be necessary to store the fields, [symbol] , for all time steps, [symbol] . This is because, for most choices of ƒ, the gradient will be a function of the arguments of ƒ. This difficulty is compounded by the fact that the values of for larger values of [symbol] are needed before the values for smaller [symbol] due to the incremental updates of the field response and/or through backpropagation of the loss metric, which may prevent the use of schemes that attempt to store only the values

$$\frac{\partial L}{\partial {x}_{i}} ,$$

at an immediate time step.

An additional difficulty is further illustrated when computing the structural gradient,

$$\frac{d L}{d z} ,$$

which is given by:

$$\frac{d L}{d z} = {\sum }_{i} \frac{d L}{d {x}_{i}} \frac{\partial {x}_{i}}{\partial z} .$$

For completeness, the full form of the first term in the sum,

$$\frac{d L}{d z} ,$$

is expressed as:

$$\frac{d L}{d {x}_{i}} = \frac{\partial L}{\partial {x}_{i}} + \frac{d L}{d {x}_{i + 1}} \frac{\partial {x}_{i + 1}}{\partial {x}_{i}}$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 726), which can be expressed as:

$$\frac{d L}{{dx}_{i}} = \frac{\partial L}{\partial {x}_{i}} + \frac{d L}{d {x}_{i + 1}} A ( z ) ,$$

$$or$$

$${∇}_{{x}_{i}} L = {A ( z )}^{T} {∇}_{{x}_{i + 1}} L + \frac{\partial {L}^{T}}{\partial {x}_{i}}$$

The adjoint update is the backpropagation of the loss gradient (e.g., from the loss metric) from later to earlier time steps and may be referred to as a backwards solve for

$$\frac{d L}{{dx}_{i}} .$$

More specifically, the loss gradient may initially be based upon the backpropagation of a loss metric determined from the operational simulation with the loss function. The second term in the sum of the structural gradient,

$$\frac{d L}{d z} ,$$

corresponds to the field gradient and is denoted as:

$$\frac{\partial {x}_{i}}{\partial z} = \frac{d ϕ ( {x}_{i - 1} , {𝒷}_{i - 1} , z )}{d z} = \frac{d A ( z )}{d z} {x}_{i - 1} + \frac{d B ( z )}{d z} {𝒷}_{i - 1} ,$$

for the particular form of ϕ described by the first equation above. Thus, each term of the sum associated depends on both for [symbol] >= [symbol] and for [symbol] < [symbol] . Since the dependency chains of these two terms are in opposite directions, it is concluded that computing

$$\frac{d L}{d z}$$

in this way requires the storage of xᵢ values for all of [symbol] . In some embodiments, the need to store all field value may be mitigated by a reduced representation of the fields.

Returning to FIG. 7A, the operational simulation 702 and adjoint simulation 704 as described above are used to optimize the initial design 730 with respect to a loss metric 722 that would typically represent a desired performance of the physical device. In some embodiments, a loss metric 722 may be used that represents a desired performance of the fabrication model 744 instead, and the operational simulation 702 and adjoint simulation 704 may be used to update the fabrication model 744 instead of (or in addition to) the initial design 730. In this way, the fabrication model 744 may be improved to more accurately represent the real result of the fabrication processes performed by the fabrication system 746.

Accordingly, FIG. 7A illustrates an optional flow wherein the initial design 730 is provided to a fabrication system 746. The initial design 730 is then used by the fabrication system 746 to fabricate an instance of the physical device based on the initial design 730. Actual (not simulated) performance of the fabricated instance of the physical device is then measured to determine an as-fabricated performance metric 748. The as-fabricated performance metric 748 is similar to the simulated performance metric 718 in that it may include a characterization of the performance of the physical device at one or more points (e.g., at the output ports of the device) and at one or more bandwidths, similar to the illustration in FIG. 2C. The performance loss value 720 and/or the loss metric 722 may be based on a comparison of the simulated performance metric 718 to the as-fabricated performance metric 748, and the loss metric 722 may be backpropagated in the adjoint simulation 704 to create a gradient 728 that may be used either to update the initial design 730 (and differences between the updated initial design 730 and the initial design 730 may be used to update the fabrication model 744) or to directly update the fabrication model 744, as described in further detail below. The flow from the initial design 730 to the fabrication system 746 and as-fabricated performance metric 748 is illustrated as optional because in some embodiments, this portion of the flow may be executed a single time for a given initial design 730, while the operational simulation 702 and adjoint simulation 704 may be executed multiple times for iterative optimization.

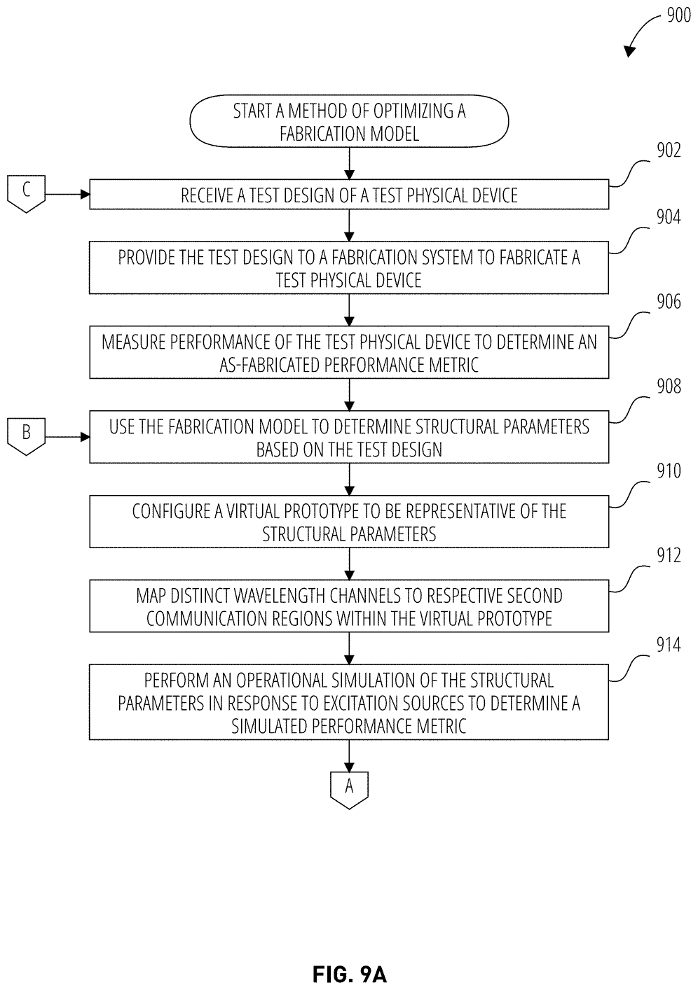

FIG. 8A-FIG. 8B are a flowchart that illustrates a non-limiting example embodiment of a method 800 for optimizing a fabrication model usable to simulate fabrication of a physical device such as a photonic integrated circuit, in accordance with various aspects of the present disclosure. In the method 800, a performance metric for a simulation of a test design is compared to a performance metric for a fabricated test physical device based on the same test design. The test design is optimized until the simulated performance metric converges to the as-fabricated performance metric in order to derive the fabricated structure of the test physical device as affected by details of the fabrication process. Differences between the test design and the derived fabricated structure are used to optimize a fabrication model that represents the details of the fabrication process, which may then be used in optimizing future designs.

It is appreciated that method 800 is a process that may be accomplished by performing operations with a system to perform iterative gradient-based optimization of a loss metric determined from a loss function that includes at least a comparison between a simulated performance metric 718 and an as-fabricated performance metric 748. In the same or other embodiments, method 800 may be included as instructions provided by at least one machine-accessible storage medium (e.g., non-transitory memory) that, when executed by a machine, will cause the machine to perform operations for generating and/or improving the fabrication model 744. It is further appreciated that the order in which some or all of the process blocks appear in method 800 should not be deemed limiting. Rather, one of ordinary skill in the art having the benefit of the present disclosure will understand that some of the process blocks may be executed in a variety of orders not illustrated, or even in parallel.

From a start block, the method 800 proceeds to block 802, where a test design (e.g., initial design 730) of a test physical device such as a photonic integrated circuit is received. In some embodiments, the physical device may be expected to have a certain functionality (e.g., perform as an optical demultiplexer). The test design may describe desired structural parameters of the physical device that are to be used for both fabrication and simulation. The virtual prototype may include a plurality of voxels that collectively describe the structural parameters of the test device. Each of the plurality of voxels may be associated with a structural value to describe the structural parameter, a field value to describe the field response (e.g., the electric and magnetic fields in one or more orthogonal directions) to physical stimuli (e.g., one or more excitation sources), and a source value to describe the physical stimuli.

It is appreciated that the “initial” test design may be a relative term. Thus, in some embodiments an initial description may be a first description of the test device described within the context of the virtual prototype (e.g., a first input design for performing a first operational simulation). However, in other embodiments, the term initial description may refer to an initial description of a particular cycle (e.g., of performing an operational simulation 702, operating an adjoint simulation 704, and updating the structural parameters). In such an embodiment, the test design or design of that particular cycle may correspond to a revised description or refined design (e.g., generated from a previous cycle). In some embodiments, the virtual prototype includes a design region that includes a portion of the plurality of voxels which have structural parameters that may be updated, revised, or otherwise changed to optimize the structural parameters. In the same or other embodiments, the structural parameters are associated with geometric boundaries and/or material compositions of the physical device based on the material properties (e.g., relative permittivity, index of refraction, etc.) of the virtual prototype.

At block 804, the test design is provided to a fabrication system to fabricate a test physical device. The fabrication system may use any suitable technique or combination of techniques to fabricate the test physical device, including but not limited to lithographic techniques such as photolithography and electron-beam lithography, sputtering, thermal evaporation, and physical and/or chemical vapor deposition. As discussed further below, while the method 800 describes receipt and processing of a single test design at once for the sake of clarity, in some embodiments multiple test physical devices based on multiple test designs may be received and provided to the fabrication system at once for fabrication on a single wafer. In some embodiments, up to tens of thousands of test physical devices may be fabricated on a single wafer and tested by wafer-scale testing techniques, thus allowing many test designs to be efficiently processed and used to improve the fabrication model even further.

At block 806, performance of the test physical device is measured to determine an as-fabricated performance metric. The performance of the test physical device may be measured at one or more points of the test physical device, including but not limited to one or more output ports. The performance may be measured by providing various inputs, including but not limited to light sources that produce various wavelengths, to one or more input ports of the physical device. In some embodiments, performance may be measured using one or more test-only input ports or output ports on the physical device that are used during testing but that are not taken into account during optimization of the design. Further, the performance of the test physical device may be tested both within frequencies that are intended for use and outside of frequencies that are intended for use in order to increase the amount of data that is available for the optimization process. Also, similar to the discussion above, though the method 800 illustrates and describes measuring performance of a single test physical device, in some embodiments the method 800 may use wafer-scale testing techniques to test more than one test physical device at a time.

At block 808, the fabrication model is used to determine structural parameters based on the test design. Because the fabrication model is intended to represent changes from structures specified in the test design that are introduced by the fabrication process used by the fabrication system, the structural parameters will likely be at least slightly different from the structure specified in the test design. In some embodiments, the fabrication model may initially not make any changes to the structure provided in the test design, but may begin to make changes once one or more iterations of the method 800 are completed. In some embodiments, the actions of block 808 may be skipped, and structural parameters of the test design may be provided directly to the virtual prototype without being altered by the fabrication model.

At block 810, a virtual prototype is configured to be representative of the structural parameters. Once the structural parameters have been determined using the fabrication model, the virtual prototype is configured (e.g., the number of voxels, shape/arrangement of voxels, and specific values for the structural values, field values, and/or source values of the voxels are set based on the structural parameters). In some embodiments the virtual prototype includes a design region optically coupled between a first communication region and a plurality of second communication regions. In some embodiments, the first communication region may correspond to an input region or port (e.g., where an excitation source originates), while the second communication may correspond to a plurality of output region or ports (e.g., when designing an optical demultiplexer that optically separates a plurality of distinct wavelength channels included in a multi-channel optical signal received at the input port and respectively guiding each of the distinct wavelength channels to a corresponding one of the plurality of output ports). However, in other embodiments, the first communication region may correspond to an output region or port, while the plurality of second communication regions corresponds to a plurality of input ports or region (e.g., when designing an optical multiplexer that optically combines a plurality of distinct wavelength signals received at respective ones of the plurality of input ports to form a multi-channel optical signal that is guided to the output port).

Block 812 shows mapping each of a plurality of distinct wavelength channels to a respective one of the plurality of second communication regions within the virtual prototype. The distinct wavelength channels may be mapped to the second communication regions by virtue of the test design. For example, the test design may associate a performance metric of the physical device with power transmission from the input port to individual output ports for mapped channels. In one embodiment, a first channel included in the plurality of distinct wavelength channels is mapped to a first output port, meaning that the performance metric of the physical device for the first channel is tied to the first output port. Similarly, other output ports may be mapped to the same or different channels included in the plurality of distinct wavelength channels such that each of the distinct wavelength channels is mapped to a respective one of the plurality of output ports (i.e., second communication regions) within the virtual prototype. In one embodiment, the plurality of second communication regions includes four regions and the plurality of distinct wavelength channels includes four channels that are each mapped to a corresponding one of the four regions. In other embodiments, there may be a different number of the second communication regions (e.g., 8 regions) and a different number of channels (e.g., 8 channels) that are each mapped to a respective one of the second communication regions.

Block 814 illustrates performing an operational simulation of the structural parameters in response to one or more excitation sources to determine a simulated performance metric. More specifically, in some embodiments an electromagnetic simulation is performed in which a field response of the photonic integrated circuit is updated incrementally over a plurality of time steps to determine how the field response of the simulated physical device changes due to the excitation source. The field values of the plurality of voxels are updated in response to the excitation sources and based, at least in part, on the structural parameters of the integrated photonic circuit. Additionally, each update operation at a particular time step may also be based, at least in part, on a previous (e.g., immediately prior) time step.

Consequently, the operational simulation simulates an interaction between the photonic device (i.e., the photonic integrated circuit) and a physical stimuli (i.e., one or more excitation sources) to determine a simulated output of the photonic device (e.g., at one or more of the output ports or regions) in response to the physical stimuli. The interaction may correspond to any one of, or combination of a perturbation, retransmission, attenuation, dispersion, refraction, reflection, diffraction, absorption, scattering, amplification, or otherwise of the physical stimuli within electromagnetic domain due, at least in part, to the structural parameters of the photonic device and underlying physics governing operation of the photonic device. Thus, the operational simulation simulates how the field response of the virtual prototype changes due to the excitation sources over a plurality of time steps (e.g., from an initial to final time step with a pre-determined step size).

In some embodiments, the simulated output may be utilized to determine one or more simulated performance metrics. For example, the excitation source may correspond to a selected one of a plurality of distinct wavelength channels that are each mapped to one of the plurality of output ports. The excitation source may originate at or be disposed proximate to the first communication region (i.e., input port) when performing the operational simulation. During the operational simulation, the field response at the output port mapped to the selected one of the plurality of distinct wavelength channels may then be utilized to determine a simulated power transmission of the photonic integrated circuit for the selected distinct wavelength channel. In other words, the operational simulation may be utilized to determine the simulated performance metric that includes determining a simulated power transmission of the excitation source from the first communication region, through the design region, and to a respective one of the plurality of second communication regions mapped to the selected one of the plurality of distinct wavelength channels. In some embodiments, the excitation source may cover the spectrum of all of the plurality of output ports (e.g., the excitation source spans at least the targeted frequency ranges for the bandpass regions for each of the plurality of distinct wavelength channels as well as the corresponding transition band regions, and at least portions of the corresponding stopband regions) to determine a performance metric (i.e., simulated power transmission) associated with each of the distinct wavelength channels for the photonic integrated circuit. In some embodiments, one or more frequencies that span the passband of a given one of the plurality of distinct wavelength channels is selected randomly to optimize the design (e.g., batch gradient descent while having a full width of each passband including ripple in the passband that meets the target specifications). In the same or other embodiments, each of the plurality of distinct wavelength channels has a common bandwidth with different center wavelengths.

The method 800 then proceeds to a continuation terminal (“terminal A”). From terminal A (FIG. 8B), the method 800 proceeds to block 816, which shows determining a loss metric based on a comparison of the simulated performance metric to the as-fabricated performance metric. In some embodiments the loss metric is determined via a loss function that includes both the simulated performance metric and the as-fabricated performance metric as input values. In some embodiments, the loss function may be a measurement of the difference between the simulated performance metric and the as-fabricated performance metric, including but not limited to a mean-squared error between the values.

At decision block 818, a determination is made regarding whether the loss metric substantially converges such that the difference between the simulated performance metric and the as-fabricated performance metric is within a threshold range and/or has ceased improving. In some embodiments, the structural parameters of the design region of the integrated photonic circuit are revised when performing the iterations to match the structure of the fabricated physical device as closely as possible, which is indicated by this convergence. In some embodiments, the determination at decision block 818 is merely based on whether a predetermined number of iterations has been performed.

If the determination is that the loss metric has not converged, then the result of decision block 818 is NO, and the method 800 proceeds to block 820. Block 820 illustrates backpropagating the loss metric via the loss function through the virtual prototype to determine an influence of changes in the structural parameter on the loss metric (i.e., a structural gradient). The loss metric is treated as an adjoint or virtual source and is backpropagated incrementally from a final time step to earlier time steps in a backwards simulation to determine the structural gradient.

Block 822 shows updating the structural parameters of the test design based on the structural gradient to adjust the loss metric. In some embodiments, adjusting for the loss metric may reduce the loss metric. However, in other embodiments, the loss metric may be adjusted or otherwise compensated in a manner that does not necessarily reduce the loss metric. In one embodiment, adjusting the loss metric may maintain fabricability while providing a general direction within the parameterization space to obtain designs that will ultimately result in performance that more closely matches the as-fabricated performance metric. In some embodiments, the revised description is generated by utilizing an optimization scheme after a cycle of operational and adjoint simulations via a gradient descent algorithm, Markov Chain Monte Carlo algorithm, or other optimization techniques. Put in another way, iterative cycles of simulating the physical device, determining a loss metric, backpropagating the loss metric, and updating the structural parameters to adjust the loss metric may be successively performed until the loss metric substantially converges such that the difference between the simulated performance metric and the as-fabricated performance metric is within a threshold range. In some embodiments, the term “converges” may simply indicate the difference is within the threshold range and/or below some threshold value. In some embodiments, the term “converges” may indicate that the error between the simulated performance metric and the as-fabricated performance metric is no longer shrinking after one or more optimization iterations (i.e., a local or global minimum has been reached). The method 800 then returns to block 808 via a continuation terminal (“terminal B”) to iterate using the updated test design.

Returning to decision block 818, if the determination is that the loss metric has converged, then the result of decision block 818 is YES and the method 800 advances to block 824. At block 824, the test design as updated by one or more iterations of the method 800 is designated as an as-fabricated design. That is, the optimized test design is considered to accurately represent the actual structure of the test physical device as it was fabricated by the fabrication system.

The method 800 then proceeds to a decision block 826, where a determination is made regarding whether more devices remain to be processed. As discussed above, in some embodiments the method 800 may be performed using a plurality of devices in order to stress a wide variety of functionality of the fabrication system. In some embodiments, the method 800 may include testing a plurality of devices created on a single wafer. Since a large number of devices may be created on a single 300 mm wafer, this may allow a large number of different designs to be tested efficiently. In some embodiments, multiple devices fabricated on a single wafer may be tested using wafer-scale testing tools. In some embodiments, the plurality of devices created on the wafer may be designed using a “design for testing” approach in order to exercise the full range of capabilities of the fabrication system. Further, the simulated performance metric and as-fabricated performance metric may be collected using wavelengths other than those intended for device operation to provide additional data for the optimization process.

Accordingly, if the method 800 is processing more than one device and more devices remain to be processed, then the result of decision block 826 is YES, and the method 800 returns to block 802 via a continuation terminal (“terminal C”) to process the test design for the next device. On this subsequent iteration, if the test designs for each device were provided together to the fabrication system in order to fabricate the test physical devices on a single wafer, then at least some of the actions of block 802, block 804, and/or block 806 may have been performed during the previous iteration for the next device, and may be skipped in the subsequent iteration.

Returning to decision block 826, if all of the devices have been processed, then the result of decision block 826 is NO, and the method 800 proceeds to block 828. Block 828 illustrates updating the fabrication model based on differences between the as-fabricated designs and the test designs. In some embodiments, the fabrication model includes a sequence of differentiable operations (or composable functions), each of which is parameterized by some degrees of freedom. Some non-limiting examples of differentiable operations within the fabrication model may include a filter operation (e.g., convolution with a square, diamond, or conical shape function, etc.) and a projection operation (e.g., sigmoid, etc.). The updates may be applied to the fabrication model using any suitable technique. For example, since the fabrication model includes differentiable operations, a gradient of the error of the fabrication model may be determined, and the fabrication model may be updated based on the gradient. As another example, the JAX machine learning framework provided by Google, LLC may be used to optimize/update the parameters of the fabrication model. In some embodiments, the fabrication model may include a neural network which may be updated using any suitable technique, including but not limited to gradient descent or an Adam optimizer.

At block 830, the updated fabrication model is provided for simulations of new initial designs. The updated fabrication model may be used in an iterative design process similar to that illustrated above in FIG. 7A-FIG. 7B for a new initial design, and the configuration portion 754 will produce structural parameters 706 that precisely duplicate an actual result that will be generated by the fabrication system, thus allowing inverse design of highly performant devices.

The method 800 then proceeds to an end block and terminates.

It will be appreciated that in the method 800, the as-fabricated design for each test design is derived. One advantage of using the method 800 to optimize the fabrication model is that the pairs of test designs and as-fabricated designs may be stored for future reference, and multiple different fabrication models (including fabrication models of different architectures) may be derived using the stored test design/as-fabricated design pairs without having to re-process the test designs (that is to say, once the pairs of test designs and as-fabricated designs are obtained, block 828 can be executed multiple times in order to optimize different fabrication models without repeating the previous portions of method 800). This allows for greater exploration of the architecture of the fabrication model with a reduced computational load.

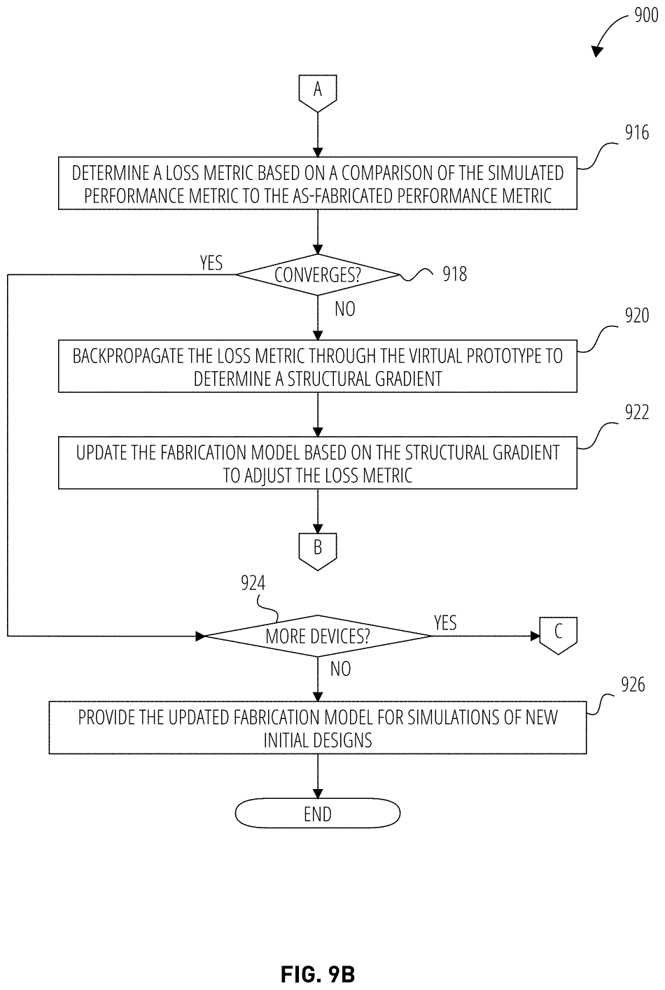

That said, it may be desirable in some embodiments to reduce the amount of computation time needed for the training of a given fabrication model. Accordingly, in some embodiments, the optimization technique may directly optimize the fabrication model instead of deriving the as-fabricated designs as an intermediate step. FIG. 9A-FIG. 9B are a flowchart that illustrates a non-limiting example embodiment of a method 900 for optimizing a fabrication model usable to simulate fabrication of a physical device such as a photonic integrated circuit, in accordance with various aspects of the present disclosure. In the method 900, a performance metric for a simulation of a test design is compared to a performance metric for a fabricated test physical device based on the same test design, similar to method 800. However, instead of optimizing the test design as described in method 800, method 900 uses the differences between the simulated performance metric and the as-fabricated performance metric to directly optimize the fabrication model.

From a start block, the method 900 proceeds to block 902, where a test design of a test physical device is received. At block 904, the test design is provided to a fabrication system to fabricate a test physical device. At block 906, performance of the test physical device is measured to determine an as-fabricated performance metric. At block 908, the fabrication model is used to determine structural parameters based on the test design. At block 910, a virtual prototype is configured to be representative of the structural parameters. Block 912 shows mapping each of a plurality of distinct wavelength channels to a respective one of the plurality of second communication regions within the virtual prototype, and block 914 illustrates performing an operational simulation of the structural parameters in response to one or more excitation sources to determine a simulated performance metric.

It will be appreciated that the steps of method 900 from block 902 to block 914 are the same as the steps of method 800 from block 802 to block 814. Accordingly, the steps of block 902 to block 914 are not described again here for the sake of brevity. It should be noted, however, that while the use of the fabrication model to determine the structural parameters based on the test design was optional at block 808, these actions are not optional in block 908 because the fabrication model is being optimized within the iterative loop in order to affect the structural parameters.

From block 914, the method 900 proceeds to a continuation terminal (“terminal A”). From terminal A (FIG. 9B), the method 900 proceeds to block 916, where a loss metric is determined based on a comparison of the simulated performance metric to the as-fabricated performance metric. Again, block 916 is similar to block 816 of method 800, and so is not described again here for the sake of brevity.

At decision block 918, a determination is made regarding whether the loss metric substantially converges such that the difference between the simulated performance metric and the as-fabricated performance metric is within a threshold range and/or has ceased improving. In some embodiments, the structural parameters generated by the fabrication model are revised when performing the iterations to match the structure of the fabricated physical device as closely as possible, which is indicated by this convergence. In some embodiments, the determination at decision block 918 is merely based on whether a predetermined number of iterations has been performed.

If the determination is that the loss metric has not converged, then the result of decision block 918 is NO, and the method 900 advances to block 920. At block 920, the loss metric is backpropagated through the virtual prototype to determine a structural gradient. Again, block 920 is similar to block 820 of method 800, and so is not described again here for the sake of brevity.

At block 922, the fabrication model is updated based on the structural gradient to adjust the loss metric. This is a departure from the actions of method 800, in which the structural gradient was used to adjust the test design. Instead, updating the fabrication model means that instead of the test design being optimized to more closely resemble the as-fabricated structure of the test physical device, the fabrication model is optimized such that the structural parameters it generates, given the test design, more closely resemble the as-fabricated structure of the test physical device. The structural gradient may be used to update the fabrication model in any suitable way. In some embodiments, the structural gradient may be used to determine a gradient of the fabrication model, and the gradient of the fabrication model may then be used in an optimization process. In some embodiments, backpropagation of the loss metric may determine the gradient of the fabrication model as well. In some embodiments, the optimization process may include JAX, gradient descent, or an Adam optimizer as discussed above. The method 900 then returns to block 908 via a continuation terminal (“terminal B”) to iterate using the updated fabrication model.

Returning to decision block 918, if the determination is that the loss metric has converged, then the result of decision block 918 is YES and the method 900 advances to decision block 924. At decision block 924, a determination is made regarding whether more devices remain to be processed. As discussed above and similar to method 800, in some embodiments the method 900 may be performed using a plurality of devices in order to account for a wide variety of functionality of the fabrication system. Accordingly, if the method 900 is processing more than one device and additional devices remain to be processed, then the result of decision block 924 is YES, and the method 900 returns to block 902 via a continuation terminal (“terminal C”) to process the test design for the next device. On this subsequent iteration, if the test designs for each device were provided together to the fabrication system in order to fabricate the test physical devices on a single wafer, then at least some of the actions of block 902, block 904, and/or block 906 may have been performed during the previous iteration for the next device, and may be skipped in the subsequent iteration.

Returning to decision block 924, if all of the devices have been processed, then the result of decision block 924 is NO, and the method 900 proceeds to block 926, where the updated fabrication model is provided for simulations of new initial designs. Again, the updated fabrication model may be used in an iterative design process similar to that illustrated above in FIG. 7A-FIG. 7B for a new initial design, and the configuration portion 754 will produce structural parameters 706 that precisely duplicate an actual result that will be generated by the fabrication system, thus allowing inverse design of highly performant devices. One will note that in method 900, the fabrication model was optimized without also deriving the as-fabricated designs, which reduces the computational complexity of the optimization process.

The method 900 then proceeds to an end block and terminates.

In the preceding description, numerous specific details are set forth to provide an understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having computer-executable instructions stored thereon that, in response to execution by one or more processors of a computing system, cause the computing system to perform actions for deriving a fabrication model for a fabrication system using an inverse design process, the actions comprising:
determining a test design for a test physical device;
measuring performance of an instance of the test physical device fabricated by the fabrication system using the test design to determine an as-fabricated performance metric;
optimizing the test design using a first loss function based on differences in a simulated performance metric of the test design and the as-fabricated performance metric to determine an as-fabricated design;
optimizing a fabrication model using a second loss function based on differences between the test design and the as-fabricated design; and
storing the optimized fabrication model for use in optimization of a new design for a new physical device.

2. The non-transitory computer-readable medium of claim 1, wherein the actions further comprise:
using the fabrication model to optimize the new design for the new physical device; and
transmitting the optimized new design for the new physical device to the fabrication system for fabrication of an instance of the new physical device.

3. The non-transitory computer-readable medium of claim 1, wherein the actions further comprise:
transmitting the test design to the fabrication system for fabrication of the instance of the test physical device.

4. The non-transitory computer-readable medium of claim 3, wherein the actions further comprise:
measuring accuracy of the fabrication model by comparing a scanning electron microscope (SEM) image of the instance of the test physical device to the as-fabricated design.

5. The non-transitory computer-readable medium of claim 1, wherein the fabrication model includes a neural network; and
wherein optimizing the fabrication model includes using at least one of gradient descent and an Adam optimizer.

6. The non-transitory computer-readable medium of claim 1, wherein the fabrication model includes a sequence of differentiable operations; and
wherein optimizing the fabrication model includes using a JAX framework.

7. The non-transitory computer-readable medium of claim 1, wherein the test design includes at least one performance goal given an expected input.

8. The non-transitory computer-readable medium of claim 1, wherein determining the test design includes providing the at least one performance goal to an inverse design process to generate the test design.

9. The non-transitory computer-readable medium of claim 1, wherein the expected input includes one or more intended wavelength spectra for operation of the test physical device; and
wherein measuring performance of the instance of the test physical device includes measuring performance of the instance of the test physical device within the one or more intended wavelength spectra and outside of the one or more intended wavelength spectra.

10. The non-transitory computer-readable medium of claim 1, wherein determining the test design for the test physical device includes determining a plurality of test designs for a plurality of test physical devices to be fabricated on a single wafer; and
wherein measuring performance of the instance of the test physical device includes measuring performance of instances of the plurality of test physical devices fabricated on the single wafer.

11. A non-transitory computer-readable medium having logic stored thereon that, in response to execution by one or more processors of a computing system, cause the computing system to perform actions for deriving a fabrication model for a fabrication system using an inverse design process, the method comprising:
determining a test design for a test physical device;
measuring performance of an instance of the test physical device fabricated by the fabrication system using the test design to determine an as-fabricated performance metric;
determining structural parameters for a simulation based on the test design and the fabrication model;
simulating performance of the test design using the structural parameters to determine a simulated performance metric;
optimizing the fabrication model using a loss function based on differences between the simulated performance metric and the as-fabricated performance metric; and
storing the optimized fabrication model for use in optimization of a new design for a new physical device.

12. The computer-implemented method of claim 11, further comprising:
using the fabrication model to optimize the new design for the new physical device; and
transmitting the optimized new design for the new physical device to the fabrication system for fabrication of an instance of the new physical device.

13. The computer-implemented method of claim 11, further comprising:
transmitting the test design to the fabrication system for fabrication of the instance of the test physical device.

14. The computer-implemented method of claim 13, further comprising:
measuring accuracy of the structural parameters by comparing a scanning electron microscope (SEM) image of the instance of the test physical device to the structural parameters.

15. The computer-implemented method of claim 11, wherein the fabrication model includes a neural network; and
wherein optimizing the fabrication model includes using at least one of gradient descent and an Adam optimizer.

16. The computer-implemented method of claim 11, wherein the fabrication model includes a sequence of differentiable operations; and
wherein optimizing the fabrication model includes using a JAX framework.

17. The computer-implemented method of claim 11, wherein the test design includes at least one performance goal given an expected input.

18. The computer-implemented method of claim 17, wherein determining the test design includes providing the at least one performance goal given the expected input to an inverse design process to generate the test design.

19. The computer-implemented method of claim 17, wherein the expected input includes one or more intended wavelength spectra for operation of the test physical device; and
wherein measuring performance of the instance of the test physical device includes measuring performance of the instance of the test physical device within the one or more intended wavelength spectra and outside of the one or more intended wavelength spectra.

20. The computer-implemented method of claim 11, wherein determining the test design for the test physical device includes determining a plurality of test designs for a plurality of test physical devices to be fabricated on a single wafer; and
wherein measuring performance of the instance of the test physical device includes measuring performance of instances of the plurality of test physical devices fabricated on the single wafer.
